(19) United States
(12) Patent Application Publication
(10) Pub. No.: US 2005/0208230 A1
(43) Pub. Date: Sep. 22, 2005

(54) Antireflection film, production process of the same, polarizing plate and image displaying apparatus

(75) Inventor: Akira Ikeda, Minami-Ashigara-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: FUJI PHOTO FILM, CO., LTD., Minami-Ashigara-shi (JP)

(21) Appl. No.: 11/079,668

(22) Filed: Mar. 15, 2005

(30) Foreign Application Priority Data
Mar. 16, 2004 (JP) 2004-074684

(51) Int. Cl. C09K 19/00

(52) U.S. Cl. 428/1.1

(57) ABSTRACT

An antireflection film comprising: a transparent support; and a low refractive index layer as an outermost layer, wherein the low refractive index layer comprises a crosslinkable compound capable of forming a cured film having a universal hardness of 75 N/mm² or more. A polarizing plate has the antireflection film as a surface protective film. An image displaying apparatus has the antireflection film or the polarizing plate.

### BACKGROUND OF THE INVENTION

1. Field of the Invention

The present invention relates to an antireflection film, and a polarizing plate and an image displaying apparatus using the same. The invention also relates to a process for producing an antireflection film.

2. Description of the Related Art

An antireflection film is generally disposed on the outermost surface of an image displaying apparatus, such as a cathode ray tube (CRT), a plasma display panel (PDP) and a liquid crystal display device (LCD), to reduce the reflectance by using the optical interference theory, whereby reduction in contrast and reflection of images due to reflection of outside light are prevented.

The antireflection film disposed on the outermost surface is demanded to have not only reduction in reflectance, but also sufficient abrasion resistance and antifouling property for withstanding various use environments of the users. However, the low refractive index layer thereof is still insufficient in antifouling property though it has sufficient hardness, as described in JP-A-10-728, JP-A-2002-53804, JP-A-2002-265866 and JP-A-2003-205581. It is also not preferred for weight production at low cost that a long period of time is required for curing the film upon production. Therefore, such a low refractive index layer has been demanded that is formed of a crosslinkable polymer and is excellent in strength and resistance to surface fouling, so as to satisfy simultaneously the low refractive index, the sufficient abrasion resistance and antifouling property, and the production suitability. In many cases, however, there is trade-off relationship among the requirements, i.e., improvement of one of the requirements deteriorates the other, and it has been difficult to satisfy simultaneously all the low refractive index, the sufficient abrasion resistance and antifouling property, and the production suitability.

### SUMMARY OF THE INVENTION

An object of the invention is to provide such an antireflection film that can be easily produced at low cost, has sufficient antireflection capability and abrasion resistance, and has antifouling property, and a process for producing the same.

Another object of the invention is to provide a polarizing plate and an image displaying apparatus, such as a liquid crystal display device, using the excellent antireflection film.

According to the invention, an antireflection film, a process for producing the same, a polarizing plate and an image displaying apparatus having the following constitutions for attaining the objects.

(1) An antireflection film comprising:
a transparent support; and
a low refractive index layer as an outermost layer,
wherein the low refractive index layer comprises a crosslinkable compound capable of forming a cured film having a universal hardness of 75 N/mm² or more.

(2) The antireflection film as described in (1) above,
wherein the low refractive index layer has a surface free energy of 25 mN/m or less.

(3) The antireflection film as described in (1) or (2) above,
wherein the crosslinkable compound is a fluorine-containing compound.

(4) The antireflection film as described in any of (1) to (3) above,
wherein the low refractive index layer comprises at least one of inorganic fine particles, a hydrolysate of an organosilane represented by formula (A) and a partial condensate of an organosilane represented by formula (A):
   (R¹⁰)ₘ—Si(X)₄₋ₘ (A)
wherein each of R¹⁰('s) independently represents a substituted or unsubstituted alkyl group or a substituted or unsubstituted aryl group;
each of X('s) independently represents a hydroxyl group or a hydrolyzable group; and
m represents an integer of from 1 to 3.

(5) The antireflection film as described in any of (1) to (4) above,
wherein the low refractive index layer comprises inorganic fine particles having a refractive index of from 1.15 to 1.40.

(6) The antireflection film as described in (1) to (5) above,
wherein the crosslinkable compound is thermosetting.

(7) A process for producing an antireflection film comprising:
applying a coating solution for forming a layer constituting an antireflection film as described in any of (1) to (6) above, so as to form an applied solution; and
curing the applied solution to form a layer,
wherein the curing is carried out by both a thermal curing and an ionizing radiation curing in combination.

(8) A polarizing plate comprising an antireflection film as described in any of (1) to (6) above.

(9) A liquid crystal display device comprising an antireflection film as described in any of (1) to (6) above or a polarizing plate as described in (8) above.

(10) An organic EL display device comprising an antireflection film as described in any of (1) to (6) above or a polarizing plate as described in (8) above.

### BRIEF DESCRIPTION OF THE DRAWING

FIG. 1 is a schematic cross sectional view showing an example of an antireflection film according to the invention.

### DETAILED DESCRIPTION OF THE INVENTION

A basic constitution of an antireflection film as one preferred embodiment of the invention will be described with reference to the drawings.

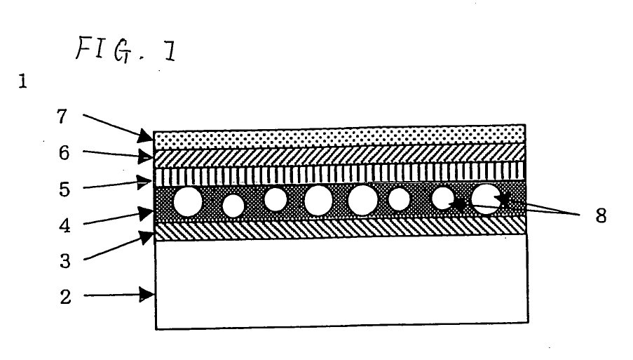

FIG. 1 is a schematic cross sectional view showing an embodiment of the antireflection film according to the invention. In the embodiment, the antireflection film 1 has a layer constitution having a transparent support 2, an electro-conductive layer 3, a hardcoat layer 4, a medium refractive index layer 5, a high refractive index layer 6 and a low refractive index layer 7, in this order. The medium refractive index layer 5 and the high refractive index layer 6 may be or may not be present, and the hardcoat layer 4 may or may not contain matte particles 8. The hardcoat layer 4 preferably has a refractive index in a range of from 1.50 to 2.00, and the low refractive index layer 7 preferably has a refractive index in a range of from 1.38 to 1.49. In the case where the high refractive index layer 6 and the medium refractive index layer 5 are used, the refractive indexes thereof may have the relationship, the low refractive index layer 7<the medium refractive index layer 5<the high refractive index layer 6. The electro-conductive layer 3 is not essential but is preferably coated, and may be present at any position adjacent to any one of the layers in the constitution of the antireflection film, rather than between the transparent support 2 and the hardcoat layer 4. The electro-conductive layer 3 may be united with any one of the layers.

The universal hardness herein is based on the ISO Standard (ISO Technical Report TR14577) disclosed in page 170 to 173, February 1997, Tofu Gijyutu.

The universal hardness of the crosslinkable compound defined in the invention is a hardness (N/mm²) obtained in the following manner. The crosslinkable compound is coated and dried to a thickness of from 10 to 20 μm on a glass plate, and then cure to form a cured film as a measuring sample. An indenter is thrust into the cured film to a depth of from 1 to 2 μm by using a microhardness meter H100, produced by Fischer Instruments Co., Ltd., to obtain the hardness.

Upon measuring the universal hardness in the invention, the glass plate is preferably a glass plate having a smooth surface, and examples thereof include a polished slide glass (26 mm×76 mm×1.2 mm), produced by Toshinriko Co., Ltd.

The sample film used in the measurement of universal hardness in the invention is necessarily cured sufficiently, and thus, the curing conditions are previously obtained therefor. The state where the film is sufficiently cured referred herein means that such curing conditions are used that in a graph showing the relationship between the universal hardness as an ordinate and the curing conditions (a product of temperature and time for the thermally crosslinkable compound, and a light irradiation amount of an ionization radiation curable compound) as an abscissa, the universal hardness exhibits no gradient with increase of the abscissa. Upon determining the curing conditions, the kinds and the amounts of the catalyst, the crosslinking agent and the polymerization initiator used in addition to the curable compound can be appropriately determined. More preferably, the kinds and the amounts of the catalyst, the crosslinking agent and the polymerization initiator used in addition to the curable compound are the same as those used upon actually producing the antireflection film.

The surface free energy (γs^{v}, unit: mN/m) of the antireflection film defined in the invention is a surface tension of the antireflection film defined as the value γs^{v}, which is the sum of values γs^{d} and γs^{h} obtained by the following simultaneous equations (1) and (2), to which contact angles θ_{H2O} and θ_{CH2I2} of pure water H₂O and methylene iodide CH₂I₂ on the antireflection film obtained experimentally with reference to D. K. Owens, J. Appl. Polym. Sci., vol. 13, p. 1741 (1969) are applied. In the case where the value γs^{v} is small, i.e., low surface free energy, the surface has high repellent property, which generally brings about excellent antifouling property.
1+cos θ_{H2O}=2√γs^{d}(√γ_{H2O}^{d}/γ_{H2O}^{v})+2√γs^{h}(√γ_{H2O}^{h}/γ_{H2O}^{v}) (1)
1+cos θ_{CH2I2}=2√γs^{d}(√_{CH2I2}^{d}/γ_{CH2I2}^{v})+2√γs^{h}(√γ_{CH2I2}^{h}/γ_{CH2I2}^{v}) (2)

In the equations, γ_{H2O}^{d}=21.8, γ_{H2O}^{h}=51.0, γ_{H2O}^{v}=72.8, γ_{CH2I2}^{d}=49.5, γ_{CH2I2}^{h}=1.3 and γ_{CH2I2}^{v}=50.8, and the measurement of the contact angles is carried out under the same conditions after humidity conditioning under the conditions at 25° C. and 60% for 1 hour or more.

The antireflection film preferably has surface free energy of 25 mN/m or less, and particularly preferably 20 mN/m or less.

The layers constituting the antireflection film of the invention, the materials for forming the layers, and the methods for forming the layers will be described below.

Inorganic Fine Particles

In the antireflection film of the invention, inorganic fine particles are preferably added to the layers for improving the film strength. The inorganic fine particles added to the respective layers may be the same as or different from each other, and are preferably adjusted in species and addition amounts corresponding to the refractive index, the film strength and the thickness of the layers. The shape of the inorganic fine particles used in the invention is not particularly limited, and various shapes, such as a spherical shape, a plate shape, a fibrous shape, a rod shape, an infinite shape and a hollow shape, may be preferably used, with the spherical shape being more preferred owing to good dispersibility thereof. The species of the inorganic fine particles is also not particularly limited, and an amorphous material is preferably used, which is preferably formed of an oxide, a nitride, a sulfide or a halide of a metal, with a metallic oxide being particularly preferred.

Examples of the metallic atom of the metallic oxide include Na, K, Mg, Ca, Ba, Al, Zn, Fe, Cu, Ti, Sn, In, W, Y, Sb, Mn, Ga, V, Nb, Ta, Ag, Si, B, Bi, Mo, Ce, Cd, Be, Pb and Ni. The average particle diameter of the inorganic fine particles is preferably from 0.001 to 0.2 μm, more preferably 0.001 to 0.1 μm, and further preferably from 0.001 to 0.06 μm, for obtaining a transparent cured film. The average particle diameter of the particles is measured with a Coulter Counter (light scattering method) or by electron microscope observation. The method of using the inorganic fine particles in the invention is not particularly limited, and for example, they may be used in a dry state or in a state dispersed in water or an organic solvent. It is also preferred in the invention that a dispersion stabilizer is used in combination for suppressing the inorganic fine particles from being aggregated or precipitated. Examples of the dispersion stabilizer include polyvinyl alcohol, polyvinylpyrrolidone, a cellulose derivative, polyamide, a phosphate ester, polyether, a surface active agent, a silane coupling agent and a titanium coupling agent. In particular, a silane coupling agent is preferably used owing to the large film strength after curing. The addition amount of the silane coupling agent as the dispersion stabilizer is not particularly limited, and for example, is preferably 1 part by weight or more per 100 parts by weight of the inorganic fine particles. The method of addition of the dispersion stabilizer is also not particularly limited. The dispersion stabilizer may be added after previously hydrolyzing, or may be added in such a manner that the silane coupling agent as the dispersion stabilizer is mixed with the inorganic fine particles, and then it is hydrolyzed and condensed, with the later method being more preferred. The inorganic fine particles that are applicable to the respective layers will be described later.

Low Refractive Index Layer

The low refractive index layer of the invention will be described.

The refractive index of the low refractive index layer of the antireflection film of the invention is from 1.38 to 1.49, and preferably from 1.38 to 1.44. The low refractive index layer preferably satisfies the following equation (I) for attaining a low reflectance.
(mλ/4)×0.7<n1d1<(mλ/4)×1.3 (I)

In the equation, m represents a positive odd number, n1 represents the refractive index of the low refractive index layer, d1 represents the thickness (nm) of the low refractive index layer, λ represents a wavelength, which is within a range of from 500 to 550 nm. The state that the equation (I) is satisfied herein means that there is a value m (which is a positive odd number, and generally 1) that satisfies the equation (I) in the aforementioned wavelength range.

Materials for forming the low refractive index layer of the invention will be described.

The low refractive index layer preferably contains, as a binder, a crosslinkable compound capable of forming a cured film having a universal hardness, which is defined as above, of 75 N/mm² or more, wherein the crosslinkable compound is crosslinked by heat or ionizing radiation. The low refractive index layer preferably further contains inorganic fine particles for improving the film strength. In this case, the inorganic fine particles are dispersed in the polymer having been crosslinked by heat or ionizing radiation.

The crosslinkable compound used in the low refractive index layer is not particularly limited as far as it is such a crosslinkable compound that is capable of being crosslinked by heat or ionizing radiation, and the universal hardness after curing satisfies the aforementioned range. A crosslinkable fluorine-containing compound is preferred, and examples thereof include a hydrolysate and a condensate of a perfluoroalkyl group-containing silane compound (such as (heptadecafluoro-1,1,2,2-tetradecyl)triethoxysilane), etc., and a fluorine-containing copolymer of a fluorine-containing monomer and a monomer for imparting a crosslinking group.

Specific examples of the fluorine-containing monomer include a fluoroolefin compound (such as fluoroethylene, vinylidene fluoride, tetrafluoroethylene, hexafluoroethylene, hexafluoropropylene and perfluoro-2,2-dimethyl-1,3-dioxol), a partially or fully fluorinated alkylester derivative of (meth)acrylic acid (such as Viscoat 6FM (produced by Osaka Organic Chemical Industry, Ltd.) and M-2020 (produced by Daikin Industries, Ltd.)), a fully or partially fluorinated vinyl ether, etc.

Examples of the monomer for imparting a crosslinking group include a (meth)acrylate monomer having a crosslinkable functional group in the molecule, such as glycidyl methacrylate, and a (meth)acrylate monomer having a carboxyl group, a hydroxyl group, an amino group or a sulfonic acid group (such as (meth)acrylic acid, methylol (meth)acrylate, hydroxyalkyl (meth)acrylate and allyl acrylate).

The photo-polymerizable group-containing polymer can be obtained by reacting a crosslinkable functional group-containing polymer with a compound having a group capable of reacting with the crosslinkable group and a photo-polymerizable group, so as to introduce the photo-polymerizable group into the polymer. Examples of the photo-polymerizable group include a (meth)acryloyl group, an alkenyl group, a cinnamoyl group, a cinnamilideneacetyl group, a benzalaectophenone group, a styrylpyridine group, an α-phenylmaleimide group, a phenyldiazide group, a sulfonylazide group, a carbonylazide group, a diazo group, an o-quinonediazide group, a furilacryloyl group, a coumarin group, a pyrone group, an anthracene group, a benzophenone group, a stilbene group, a dithiocarbamate group, a xanthate group, a 1,2,3-thiadiazole group, a cyclopropene group and an azadioxabicyclo group, and these may be used solely or in combination of two or more of them. Among these, a (meth)acryloyl group and a cinnamoyl group are preferred, and a (meth)acryloyl group is particularly preferred.

The amount of the photo-polymerizable group introduced may be arbitrarily determined, and a carboxyl group, a hydroxyl group, an amino group and a sulfonic acid group may remain from the standpoint of stability of the coated surface property, prevention of surface defects with inorganic fine particles coexisting, and improvement of the film strength.

In this specification, the terms “(meth)acryloyl”, “(meth)acrylate”, “(meth)acrylic acid” and the like mean “acryloyl and/or methacryloyl”, “acrylate and/or methacrylate”, “acrylic acid and/or methacrylic acid” and the like, respectively.

In addition to the copolymer of the aforementioned components, a copolymer obtained by copolymerizing with other monomers than them may be used. The monomer that can be used in combination is not particularly limited, and examples thereof include an olefin compound (such as ethylene, propylene, isoprene, vinyl chloride and vinylidene chloride), an acrylate ester (such as methyl acrylate, ethyl acrylate and 2-ethylhexyl acrylate), a methacrylate ester (such as methyl methacrylate, ethyl methacrylate, butyl methacrylate and ethylene glycol dimethacrylate), a styrene derivative (such as styrene, divinylbenzene, vinyltoluene and α-methylstyrene), a vinyl ether compound (such as methyl vinyl ether), a vinyl ester compound (such as vinyl acetate, vinyl propyonate and vinyl cinnamate), an acrylamide compound (such as N-tert-butylacrylamide and N-cyclohexylacrylamide), a methacrylamide compound, and an acrylonitrile derivative.

The molecular weight of the polymer that can be preferably used in the invention is preferably 5,000 or more, more preferably from 10,000 to 500,000, and most preferably from 15,000 to 200,000, in terms of weight average molecular weight. The polymers having different molecular weights may be used in combination for improving the surface property of the coated film and improving the abrasion resistance.

A curing agent may be appropriately used in combination with the polymer as described in JP-A-10-25388 and JP-A-10-147739, and it is preferred to use a compound having a polyfunctional polymerizable unsaturated group in combination as described in JP-A-2000-17028 and JP-A-2002-145952. In the invention, furthermore, those described in JP-A-2002-243907, JP-A-2002-372601, JP-A-2003-26732, JP-A-2003-222702, JP-A-2003-294911, JP-A-2003-329804, JP-A-2004-4444 and JP-A-2004-45462 that are within the scope of the invention may be used.

Specific examples of the photo-polymerizable polyfunctional monomer having a photo-polymerizable functional group used in the low refractive index layer include a (meth)acrylate diester of an alkylene glycol, such as neopentylglycol acrylate, 1,6-hexanediol (meth)acrylate and propylene glycol di(meth)acrylate; a (meth)acrylate diester of a polyoxyalkylene glycol, such as triethylene glycol di(meth)acrylate, dipropylene glycol di(meth)acrylate, polyethylene glycol di(meth)acrylate and polypropylene glycol di(meth)acrylate;
a (meth)acrylate diester of a polyhydric alcohol, such as pentaerythritol di(meth)acrylate; and a (meth)acrylate diester of an ethylene oxide or propylene oxide adduct, such as 2,2-bis{4-(acryloxydiethoxy)phenyl}propane and 2,2-bis{4-(acryloxypolypropoxy)phenyl}propane.

Furthermore, a (meth)acrylate compound, a urethane (meth)acrylate compound and a polyester (meth)acrylate compound are also preferably used as the photo-polymerizable polyfunctional monomer.

Among these, an ester of polyhydric alcohol and (meth)acrylic acid is preferred. A polyfunctional monomer having three or more (meth)acryloyl groups in one molecule is more preferred. Specific examples thereof include trimethylolpropane tri(meth)acrylate, trimethylolethane tri(meth)acrylate, 1,2,4-cyclohexane tetra(meth)acrylate, pentaglycerol triacrylate, pentaerythritol tetra(meth)acrylate, pentaerythritol tri(meth)acrylate, dipentaerythritol triacrylate, dipentaerythritol pentaacrylate, dipentaerythritol tetra(meth)acrylate, dipentaerythritol hexa(meth)acrylate, tripentaerythritol triacrylate and tripentaerythritol hexaacrylate. The polyfunctional monomer may be used in combination of two or more kinds thereof.

In the invention, the universal hardness of the crosslinkable compound of the low refractive index layer after curing is 75 N/mm² or more, preferably 90 N/mm² or more, and particularly preferably 120 N/mm² or more. In the invention, the aforementioned condition for the universal hardness may be satisfied solely by the crosslinkable polymer, or the condition may be satisfied by the combination use with a crosslinkable low molecular polymerizable compound even if the polymer itself is low in hardness.

The inorganic fine particles used in the low refractive index layer preferably have a low refractive index, and preferred examples of the inorganic fine particles include silica and magnesium fluoride, with silica being particularly preferred. For lowering the refractive index, porous particles, porous particles having coated on the surface thereof and particles having cavities inside the shell are preferred. The shell may be a porous material having fine pores or may be a material obtained by clogging the fine pores to seal the cavities, and from the standpoint of improvement in abrasion resistance, a material obtained by clogging the fine pores to seal the cavities is preferred. The hollow silica fine particles disclosed in JP-A-2001-233611 and JP-A-2002-79616 are particularly preferred from the standpoint of reduction of refractive index and abrasion resistance. The refractive index of the inorganic particles is preferably from 1.15 to 1.40, more preferably from 1.15 to 1.38, and most preferably from 1.18 to 1.31. To assure a physical strength of hollow silica fine particles, inorganic particles need to have the refractive index of 1.15 or more. The average particle diameter of the inorganic fine particles is preferably from 0.001 to 0.20 μm, more preferably from 0.005 to 0.10 μm, and most preferably from 0.005 to 0.05 μm. The inorganic fine particles used as a filler preferably has a uniform particle diameter (i.e., monodisperse). In the invention, plural kinds of particles having different average particle diameters may be used in combination. Examples of a preferred combination include a combination of particles having an average particle diameter of from 0.005 to 0.015 μm and particles having an average particle diameter of from 0.030 to 0.10 μm, and a combination of particles having an average particle diameter of from 0.030 to 0.060 μm and particles having an average particle diameter of from 0.060 to 0.10 μm. The specific surface area of the inorganic fine particles is preferably from 10 to 400 m²/g, more preferably from 20 to 200 m²/g, and most preferably from 30 to 150 m²/g. The addition amount of the inorganic fine particles is preferably from 5 to 90% by weight, more preferably from 10 to 70% by weight, and particularly preferably from 10 to 50% by weight, based on the total weight of the low refractive index layer.

It is also preferred that the inorganic fine particles are subjected to a surface treatment before using. Examples of the surface treatment include a physical surface treatment, such as a plasma discharge treatment and a corona discharge treatment, and a chemical surface treatment using a coupling agent, and the use of the coupling agent is preferred. Preferred examples of the coupling agent include an organoalkoxymetallic compound (such as titanium coupling agent and a silane coupling agent). In the case where the inorganic fine particles are formed of silica, the silane coupling treatment is particularly effective. Examples of surface treating agents that can be preferably used in the invention include the compounds described later for a hydrolysate of an organosilane compound and a partial condensate thereof. Particularly preferred examples thereof include compounds having a (meth)acrylate group or an epoxy group at ends thereof. As for the catalyst for the surface treatment, the same materials may be used. The amount of the surface treating agent is generally from 0.1 to 100 parts by weight, preferably from 1 to 80 parts by weight, and most preferably from 3 to 50 parts by weight, based on the inorganic particles.

The low refractive index layer of the invention may contain a known silicone, fluorine or fluoroalkylsilicone compound. In the case where the compound is added, the amount thereof is preferably from 0.01 to 20% by weight, more preferably from 0.05 to 10% by weight, and particularly preferably from 0.1 to 5% by weight, based on the total solid content of the low refractive index layer.

Preferred examples of the silicone compound include a compound containing plural dimethylsilyloxy units as repeating units and having a substituent in at least one of the ends of the compound chain and the side chain. The compound having dimethylsilyloxy units as repeating units may further contain other repeating units than the dimethylsilyloxy units. The substituent may be the same or different, and plural substituents are preferably contained. Preferred examples of the substituent include a group containing an acryloyl group, a methacryloyl group, a vinyl group, an aryl group, a cinnamoyl group, an epoxy group, an oxetanyl group, a hydroxyl group, a fluoroalkyl group, a polyoxyalkylene group, a carboxyl group or an amino group. The molecular weight is not particularly limited, and it is preferably 100,000 or less, more preferably 50,000 or less, particularly preferably from 3,000 to 30,000, and most preferably from 10,000 to 20,000. The content of silicon atoms in the silicone compound is not particularly limited, and it is preferably 18% by weight or more, particularly preferably from 25.0 to 37.8% by weight, and most preferably from 30.0 to 37.0% by weight. Preferred examples of the silicone compound include X-22-174DX, X-22-2426, X-22-164B, X-22-164C, X-22-170DX, X-22-176D and X-22-1821, all trade names, produced by Shin-Etsu Chemical Co., Ltd., FM-0725, FM-7725, FM-4421, FM-5521, FM-6621 and FM-1121, all trade names, produced by Chisso Corp., and DMS-U22, RMS-033, RMS-083, UMS-182, DMS-H21, DMS-H31, HMS-301, FMS121, FMS123, FMS131, FMS141 and FMS221, all trade names, produced by Gelest, Inc., but the invention is not limited to them.

The fluorine compound is preferably a compound having a fluoroalkyl group. The fluoroalkyl group preferably has from 1 to 20 carbon atoms, more preferably from 1 to 10 carbon atoms, and may have a linear structure (such as —CF₂CF₃, —CH₂(CF₂)₄H, —CH₂(CF₂)₈CF₃ and —CH₂CH₂(CF₂)₄H), a branched structure (such as —CH(CF₃)₂, —CH₂CF(CF₃)₂, —CH(CH₃)CF₂CF₃ and —CH(CH₃)(CF₂)₅CF₂H), an alicyclic structure (preferably a 5-membered ring or a 6-membered ring, such as a perfluorocyclohexyl group, a perfluorocyclopentyl group and an alkyl group substituted with the group), or an ether bond (such as —CH₂OCH₂CF₂CF₃, —CH₂CH₂OCH₂C₄F₈H, —CH₂CH₂OCH₂CH₂C₂F₅ and —CH₂CH₂OCF₂CF₂OCF₂CF₂H). Plural fluoroalkyl groups may be contained in one molecule.

The fluorine compound preferably further contains such a substituent that contributes to the bond formation or the solubility with the film of the low refractive index layer. The substituents may be the same or different, and plural substituents are preferably contained. Preferred examples of the substituent include an acryloyl group, a methacryloyl group, a vinyl group, an aryl group, a cinnamoyl group, an epoxy group, an oxetanyl group, a hydroxyl group, a polyoxyalkylene group, a carboxyl group and an amino group. The fluorine compound may be a polymer or an oligomer with a compound containing no fluorine atom, and the molecular weight thereof is not particularly limited. The fluorine atom content of the fluorine compound is not particularly limited, and it is preferably 20% by weight or more, particularly preferably from 30 to 70% by weight, and most preferably from 40 to 70% by weight. Preferred examples of the fluorine compound include R-2020, M-2020, R-3833 and M-3833, all trade names, produced by Daikin Industries, Ltd., and Megafac F-171, F-172 and F-179A and Defensa MCF-300, all trade names, produced by Dainippon Ink And Chemicals, Inc., but the invention is not limited to them.

A cationic surface active agent or a dust controlling or antistatic agent, such as a polyoxyalkylene compound, may be added to impart such characteristics as dust controlling property and antistatic property. The dust controlling agent and the antistatic agent may be contained in such a state that the structural unit thereof is contained as a part of the silicone compound or the fluorine compound. In the case where they are added as additives, the amount thereof is preferably from 0.01 to 20% by weight, more preferably from 0.05 to 10% by weight, and particularly preferably from 0.1 to 5% by weight, based on the total solid content of the low refractive index layer. Preferred examples of the compound include Megafac F-150, a trade name, produced by Dainippon Ink And Chemicals, Inc., and SH-3748, a trade name, produced by Toray Dow Corning Co., Ltd., but the invention is not limited to them.

In the invention, it is preferable in view of abrasion resistance that at least one of a hydrolysate of an organosilane compound and a partial condensate thereof, i.e., a so-called sol component (hereinafter referred to as “sol component”) is contained in at least one layer of the hard coat layer and the low refractive index layer. The hydrolysate of the organosilane compound and a partial condensate thereof used in the invention will be described in detail below. The organosilane compound is represented by the following general formula (A).
(R¹⁰)ₘ—Si(X)₄₋ₘ (A)

In the general formula (A), R¹⁰ represents a substituted or unsubstituted alkyl group or a substituted or unsubstituted aryl group. Examples of the alkyl group include methyl, ethyl, propyl, isopropyl, hexyl, decyl and hexadecyl. The alkyl group preferably has from 1 to 30 carbon atoms, more preferably from 1 to 16 carbon atoms, and particularly preferably from 1 to 6 carbon atoms. Examples of the aryl group include phenyl and naphthyl, and a phenyl group is preferred.

X represents a hydroxyl group or a hydrolyzable group. Examples of the hydrolyzable group include an alkoxy group (preferably an alkoxy group having from 1 to 5 carbon atoms, examples of which include a methoxy group and an ethoxy group), a halogen atom (such as Cl, Br and I), and a group represented by R²COO (wherein R² preferably represents a hydrogen atom or an alkyl group having from 1 to 5 carbon atoms, and examples of the group include CH₃COO and C₂H₅COO), and an alkoxy group is preferred, with a methoxy group or an ethoxy group being particularly preferred. m represents an integer of from 1 to 3. In the case where there are plural groups represented by R¹⁰ or X, the plural groups represented by R¹⁰ or X may be the same as or different from each other. m preferably represents 1 or 2, and particularly preferably 1.

The substituent contained in R¹⁰ is not particularly limited, and examples thereof include a halogen atom (such as fluorine atom, a chlorine atom and a bromine atom), a hydroxyl group, a mercapto group, a carboxyl group, an epoxy group, an alkyl group (such as methyl, ethyl, i-propyl, propyl and t-butyl), an aryl group (such as phenyl and naphthyl), an aromatic heterocyclic group (such as furyl, pyrazolyl and pyridyl), an alkoxy group (such as methoxy, ethoxy, i-propoxy and hexyloxy), an aryloxy group (such as phenoxy), an alkylthio group (such as methylthio and ethylthio), an arylthio group (such as phenylthio), an alkenyl group (such as vinyl and 1-propenyl), an acyloxy group (such as acetoxy, acryloyloxy and methacryloyloxy), an alkoxycarbonyl group (such as methoxycarbonyl and ethoxycarbonyl), an aryloxycarbonyl group (such as phenoxycarbonyl), a carbamoyl group (such as carbamoyl, N-methylcarbamoyl, N,N-dimethylcarbamoyl and N-methyl-N-octylcarbamoyl), and an acylamino group (such as acetylamino, benzoylamino, acrylamino and methacrylamino), and these substituents may be further substituted.

In the case where there are plural groups represented by R¹⁰, it is preferred that at least one of them is a substituted alkyl group or a substituted aryl group, and among these, an organosilane compound having a vinyl-polymerizable group represented by the following general formula (B) is preferred.
General Formula (B)

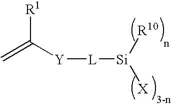

In the general formula (B), R¹ represents a hydrogen atom, a methyl group, a methoxy group, an alkoxycarbonyl group, a cyano group, a fluorine atom or a chlorine atom. Examples of the alkoxycarbonyl group include a methoxycarbonyl group and an ethoxycarbonyl group. Among these, a hydrogen atom, a methyl group, a methoxy group, a methoxycarbonyl group, a cyano group, a fluorine atom and a chlorine atom are preferred, a hydrogen atom, a methyl group, a methoxycarbonyl group, a fluorine atom and a chlorine atom are more preferred, with a hydrogen atom and a methyl group being particularly preferred.

Y represents a single bond, an ester group, an amide group, an ether group or a urea group. Among these, a single bond, an ester group and an amide group are preferred, and a single bond and an ester group are more preferred, with an ester group being particularly preferred.

L represents a divalent linking group. Specific examples thereof include a substituted or unsubstituted alkylene group, a substituted or unsubstituted arylene group, a substituted or unsubstituted alkylene group having a linking group (such as ether, ester and amide) thereinside, and a substituted or unsubstituted arylene group having a linking group thereinside. Among these, a substituted or unsubstituted alkylene group having from 2 to 10 carbon atoms, a substituted or unsubstituted arylene group having from 6 to 20 carbon atoms and an alkylene group having a linking group thereinside and having from 3 to 10 carbon atoms are preferred, and an unsubstituted alkylene group, an unsubstituted arylene group and an alkylene group having an ether or ester linking group thereinside are more preferred, with an unsubstituted alkylene group and an alkylene group having an ether or ester linking group thereinside being particularly preferred. Examples of the substituent include a halogen atom, a hydroxyl group, a mercapto group, a carboxyl group, an epoxy group, an alkyl group and an aryl group, and these substituents may be further substituted.

n represents 0 or 1. In the case where there are plural groups represented by X, the plural groups represented by X may be the same as or different from each other. n is preferably 0.

R¹⁰ has the same meaning as in the general formula (A), preferably a substituted or unsubstituted alkyl group or an unsubstituted aryl group, with an unsubstituted alkyl group and an unsubstituted aryl group being more preferred.

X has the same meaning as in the general formula (A), preferably a halogen atom, a hydroxyl group, an unsubstituted alkoxy group, more preferably a chlorine atom, a hydroxyl group and an unsubstituted alkoxy group having from 1 to 6 carbon atoms, and a hydroxyl group and an alkoxy group having from 1 to 3 carbon atoms are further preferred, with a methoxy group being particularly preferred.

Two or more kinds of the compound represented by the general formula (A) or the general formula (B) may be used in combination. Specific examples of the compound represented by the general formula (A) or the general formula (B) are described below, but the invention is not limited to them.

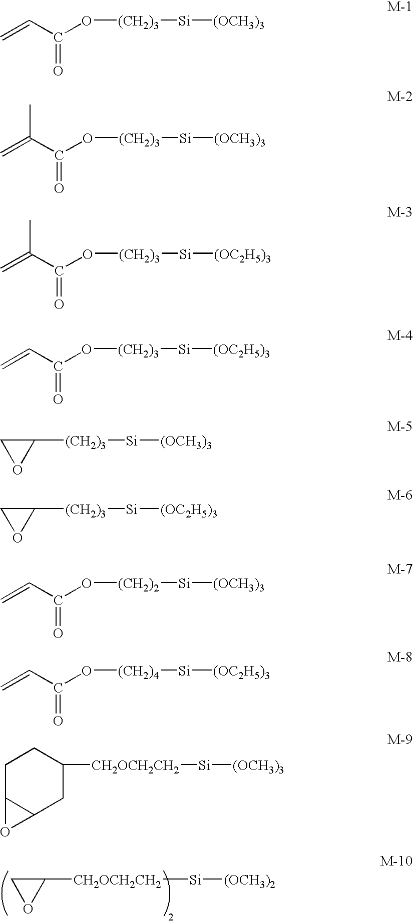

Among these specific examples, Compounds (M-1), (M-2) and (M-5) are particularly preferred.

Preferred examples of the layer constitution of the antireflection film of the invention are shown below. In the following examples, indication of an antifouling layer is omitted if provided.
transparent support/low refractive index layer
transparent support/antidazzle layer/low refractive index layer
transparent support/antidazzle layer/antistatic layer/low refractive index layer
transparent support/antistatic layer/antidazzle layer/low refractive index layer
transparent support/hardcoat layer/antistatic layer/low refractive index layer
transparent support/antistatic layer/hardcoat layer/low refractive index layer
transparent support/hardcoat layer/high refractive index layer/low refractive index layer
transparent support/hardcoat layer/medium refractive index layer/high refractive index layer/low refractive index layer
transparent support/antidazzle layer/high refractive index layer/low refractive index layer
transparent support/antidazzle layer/medium refractive index layer/high refractive index layer/low refractive index layer
transparent support/antistatic layer/hardcoat layer/medium refractive index layer/high refractive index layer/low refractive index layer
antistatic layer/transparent support/hardcoat layer/medium refractive index layer/high refractive index layer/low refractive index layer
transparent support/antistatic layer/antidazzle layer/medium refractive index layer/high refractive index layer/low refractive index layer
antistatic layer/transparent support/antidazzle layer/medium refractive index layer/high refractive index layer/low refractive index layer
antistatic layer/transparent support/antidazzle layer/high refractive index layer/low refractive index layer/high refractive index layer/low refractive index layer

In order to lower the reflectivity, such an antireflection film is preferred that contains a constitution of medium refractive index layer/high refractive index layer/low refractive index layer disclosed, for example, in JP-A-2003-262702.

Hardcoat Layer

The hardcoat layer constituting the antireflection film of the invention will be described below.

The hardcoat layer is constituted by a binder for imparting hardcoat capability, and depending on necessity, matte particles for imparting antidazzle property and inorganic fine particles for attaining a high refractive index, prevention of crosslinking shrinkage and high strength. The binder is preferably a polymer having a saturated hydrocarbon chain or a polyether chain as a main chain, and more preferably a polymer having a saturated hydrocarbon chain as a main chain. The binder polymer preferably has a crosslinked structure. The binder polymer having a saturated hydrocarbon chain as a main chain is preferably a polymer of an ethylenic unsaturated monomer. The binder polymer having a saturated hydrocarbon chain as a main chain and having a crosslinked structure is preferably a (co)polymer of a monomer having two or more ethylenic unsaturated groups. In order to attain a high refractive index, the monomer preferably contains, in the structure thereof, an aromatic ring or at least one atom selected from a halogen atom other than fluorine, a sulfur atom, a phosphorous atom and a nitrogen atom.

Examples of the monomer having two or more ethylenic unsaturated groups include an ester of a polyhydric alcohol and (meth)acrylic acid (such as ethylene glycol di(meth)acrylate, 1,4-dicyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, pentaerythritol hexa(meth)acrylate, 1,3,5-cyclohexanetriol triacrylate, polyurethane polyacrylate and polyester polyacrylate), vinylbenzene and a derivative thereof (such as 1,4-divinylbenzene, 4-vinylbenzoic acid-2-acryloylethyl ester and 1,4-divinylcyclohexanone), a vinylsulfone compound (such as divinylsulfone), an acrylamide compound (such as methylene bisacrylamide), and a methacrylamide compound.

Specific examples of the high refractive index monomer include bis(4-methacryloylthiophenyl)sulfide, vinylnaphthalene, vinylphenylsulfide and 4-methacryloxyphenyl-4′-methoxyphenyl thioether.

The monomer having an ethylenic unsaturated group can be polymerized by irradiation by ionizing radiation or heating in the presence of a photo-radical initiator or a heat-radical initiator. Therefore, a coating solution containing the monomer having an ethylenic unsaturated group, a photo-radical initiator or a heat-radical initiator, the matte particles and the inorganic fine particles is prepared, and the coating solution is coated on a transparent support and then cured through polymerization reaction by ionizing radiation or heat to form the antireflection film.

The polymer having a polyether chain as a main chain is preferably a ring-opening polymer of a polyfunctional epoxy compound. The ring-opening polymerization of the polyfunctional epoxy compound can be carried out by irradiation of ionizing radiation or heating in the presence of a photo-acid generating agent or a heat-acid generating agent. Therefore, a coating solution containing the polyfunctional epoxy compound, a photo-acid generating agent or a heat-acid generating agent, the matte particles and the inorganic fine particles is prepared, and the coating solution is coated on a transparent support and then cured through polymerization reaction by ionizing radiation or heat to form the antireflection film.

It is also possible that, instead of or in addition to the monomer having two or more ethylenic unsaturated groups, a crosslinkable functional group is introduced into the polymer by using a monomer having a crosslinkable functional group, and the crosslinked structure is introduced into the binder polymer through reaction of the crosslinkable functional group. Examples of the crosslinkable functional group include an isocyanate group, an epoxy group, an aziridine group, an oxazoline group, an aldehyde group, a carbonyl group, a hydrazine group, a carboxyl group, a methylol group and an active methylene group. Vinylsulfonic acid, an acid anhydride, a cyanoacrylate derivative, melamine, an etherified methylol, ester or urethane, and a metallic alkoxide, such as tetramethoxysilane, may also be used as the monomer for introducing the crosslinked structure. Such a functional group may also be used that exerts crosslinkability as a result of decomposition reaction, such as a blocked isocyanate group. In other words, the crosslinkable functional group in the invention may be that showing reactivity as a result of decomposition although it does not exert reactivity as it is. The binder polymer having a crosslinkable functional group may be coated and then heated to form the crosslinked structure.

The hardcoat layer may contain, depending on necessity, matte particles, such as particles of an inorganic compound or resin particles, having an average particle diameter of from 1 to 10 μm, preferably from 1.5 to 7.0 μm. Specific examples of the matte particles include particles of inorganic particles, such as silica particles and TiO₂ particles, and resin particles, such as crosslinked acrylate particles, crosslinked acrylate-styrene particles, crosslinked styrene particles, melamine resin particles and benzoguanamine resin particles. Among these, crosslinked acrylate particles, crosslinked acrylate-styrene particles and crosslinked styrene particles are preferred. The shape of the matte particles may be a true spherical shape or an infinite shape. Two or more kinds of different matte particles may be used in combination. The matte particles are preferably contained in the antidazzle hardcoat layer in an amount of from 10 to 1,000 mg/m², and more preferably from 30 to 100 mg/m². In a particularly preferred embodiment, crosslinked styrene particles are used as the matte particles, and crosslinked styrene particles having a particle diameter larger than ½ of the thickness of the hardcoat layer occupies from 40 to 100% of the total crosslinked styrene particles. The particle size distribution of the matte particles is measured by the Coulter Counter method, and the measured distribution is converted to the particle number distribution.

In order to increase the refractive index of the hardcoat layer, the hardcoat layer preferably contains, in addition to the matte particles, such inorganic fine particles that are formed of at least one oxide of a metal selected from titanium, zirconium, aluminum, indium, zinc, tin and antimony, and have an average particle diameter of from 0.001 to 0.2 μm, preferably from 0.001 to 0.1 μm, and more preferably from 0.001 to 0.06 μm. Specific examples of the inorganic fine particles used in the hardcoat layer include TiO₂, ZrO₂, Al₂O₃, In₂O₃, ZnO, SnO₂, Sb₂O₃ and ITO, and TiO₂ and ZrO₂ are particularly preferred for attaining a high refractive index. The surface of the inorganic fine particles is preferably subjected to a silane coupling treatment or a titanium coupling treatment, and such a surface treating agent is preferably used that imparts a functional group capable of reacting with the binder to the surface of the inorganic fine particles as a filler.

The addition amount of the inorganic fine particles is preferably from 10 to 90%, more preferably from 20 to 80%, and particularly preferably from 30 to 75%, based on the total weight of the hardcoat layer.

The inorganic fine particles cause scattering of light owing to the particle diameter thereof sufficiently smaller than the wavelength of light, and the dispersed body obtained by dispersing the inorganic fine particles as a filler in the binder polymer behaves as an optically uniform substance.

The refractive index of the mixture of the binder and the inorganic fine particles of the hardcoat layer is preferably from 1.57 to 2.00, and more preferably from 1.60 to 1.80. A refractive index within the range can be attained by appropriately selecting the species and the amount of the binder and the inorganic particles. The specific selection thereof may be determined experimentally in advance.

The thickness of the hardcoat layer is preferably from 1 to 10 μm, and more preferably from 1.2 to 6 μm.

High (Medium) Refractive Index Layer

In the case where the high refractive index layer is used in the invention, the refractive index thereof is preferably from 1.65 to 2.40, and more preferably from 1.70 to 2.20. In the case where the medium refractive index layer is used in the invention, the refractive index thereof is adjusted to a value between the refractive index of the low refractive index layer and the refractive index of the high refractive index layer. The refractive index of the medium refractive index layer is preferably from 1.55 to 1.80. The high refractive index layer and the medium refractive index layer preferably have a haze of 3% or less.

The high refractive index layer and the medium refractive index layer in the invention each is preferably a cured product of a composition containing inorganic fine particles having a high refractive index dispersed in a monomer, an initiator and an organosilane compound described later. The inorganic fine particles are preferably formed of an oxide of a metal (such as aluminum, titanium, zirconium and antimony), and fine particles of titanium dioxide are most preferred from the standpoint of refractive index. In the case where a monomer and an initiator are used, the monomer is cured through polymerization reaction with ionizing radiation or heat after coating, so as to form the medium refractive index layer or the high refractive index layer excellent in abrasion resistance and adhesion strength. The inorganic fine particles preferably have an average particle diameter of from 10 to 100 nm.

As the titanium dioxide fine particles, such inorganic fine particles are preferred that contains titanium dioxide as a major component and at least one element selected from cobalt, aluminum and zirconium. The major component referred herein. means a component having the largest content (percent by weight) among the components constituting the particles.

The inorganic fine particles containing titanium dioxide as a major component in the invention preferably has a refractive index of from 1.90 to 2.80, more preferably from 2.10 to 2.80, and most preferably from 2.20 to 2.80.

The primary particles of the inorganic fine particles containing titanium dioxide as a major component preferably has a weight average particle diameter of from 1 to 200 nm, more preferably from 1 to 150 nm, further preferably from 1 to 100 nm, and particularly preferably from 1 to 80 nm.

The particle diameter of the inorganic fine particles can be measured by the light scattering method or by using an electron micrograph. The inorganic fine particles preferably have a specific surface area of from 10 to 400 m²/g, more preferably from 20 to 200 m²/g, and most preferably from 30 to 150 m²/g.

The crystalline structure of the inorganic fine particles containing titanium dioxide as a major component preferably contains a rutile structure, a mixed crystal structure of rutile and anatase, an anatase structure or an amorphous structure as a major component, and in particular, a rutile structure preferably constitutes a major component. The major component referred herein means a component having the largest content (percent by weight) among the components constituting the particles.

By containing at least one element selected from Co (cobalt), Al (aluminum) and Zr (zirconium) in the inorganic fine particles containing titanium dioxide as a major component, the photocatalytic activity owned by titanium dioxide can be suppressed to improve the weather resistance of the high refractive index layer and the medium refractive index layer in the invention.

A particularly preferred element contained in the inorganic fine particles is Co (cobalt). Two or more elements may be used in combination.

Dispersing Agent

A dispersing agent may be used upon dispersing the inorganic fine particles containing titanium dioxide as a major component used in the high refractive index layer and the medium refractive index layer in the invention.

A dispersing agent having an anionic group is preferably used upon dispersing the inorganic fine particles containing titanium dioxide as a major component.

As the anionic group, a group having an acidic proton, such as a carboxyl group, a sulfonic acid group (and a sulfo group), a phosphoric acid group (and a phosphono group) and a sulfonamide group, and a salt thereof are effectively used, and a carboxyl group, a sulfonic acid group, a phosphoric acid group, and a salt thereof are preferred, with a carboxyl group and a phosphoric acid group being particularly preferred. The number of the anionic group contained in one molecule of the dispersing agent may be 1 or more.

Plural anionic groups may be contained for further improving the dispersibility of the inorganic fine particles. The average number thereof is preferably 2 or more, more preferably 5 or more, and particularly preferably 10 or more. Plural kinds of the anionic groups may be contained in one molecule of the dispersing agent.

It is preferred that the dispersing agent further contains a crosslinkable or polymerizable functional group. Examples of the crosslinkable or polymerizable functional group include an ethylenic unsaturated group capable of exerting addition reaction or polymerization reaction with a radical species (such as a (meth)acryloyl group, an allyl group, a styryl group and a vinyloxy group), and a polycondensation reaction group (such as a hydrolyzable silyl group and an N-methylol group), and preferably a functional group having an ethylenic unsaturated group.

Preferred examples of the dispersing agent used upon dispersing the inorganic fine particles containing titanium dioxide as a major component used in the high refractive index layer in the invention include such a dispersing agent that has an anionic group and a crosslinkable or polymerizable functional group, and has a crosslinkable or polymerizable group on a side chain.

The weight average molecular weight (Mw) of the dispersing agent having an anionic group and a crosslinkable or polymerizable functional group and having a crosslinkable or polymerizable group on a side chain is not particularly limited and is preferably 1,000 or more. The weight average molecular weight (Mw) of the dispersing agent is more preferably 2,000 to 1,000,000, further preferably from 5,000 to 200,000, and particularly preferably 10,000 to 100,000.

The using amount of the dispersing agent with respect to the inorganic fine particles is preferably in a range of from 1 to 50% by weight, more preferably in a range of from 5 to 30% by weight, and most preferably in a range of from 5 to 20% by weight. Two or more kinds of the dispersing agent may be used in combination.

Formation Method of High (Medium) Refractive Index Layer

The inorganic fine particles containing titanium dioxide as a major component used in the high refractive index layer and the medium refractive index layer are used in the form of a dispersed product for forming the high refractive index layer and the medium refractive index layer.

The inorganic fine particles are dispersed in a dispersion medium in the presence of the aforementioned dispersing agent.

The dispersion medium is preferably a liquid having a boiling point of from 60 to 170° C. Examples of the dispersion medium include water, an alcohol (such as methanol, ethanol, isopropanol, butanol and benzyl alcohol), a ketone (such as acetone, methyl ethyl ketone, methyl isobutyl ketone and cyclohexanone), an ester (such as methyl acetate, ethyl acetate, propyl acetate, butyl acetate, methyl formate, ethyl formate, propyl formate and butyl formate), an aliphatic hydrocarbon (such as hexane and cyclohexane), a halogenated hydrocarbon (such as methylene chloride, chloroform and carbon tetrachloride), an aromatic hydrocarbon (such as benzene, toluene and xylene), an amide (such as dimethylformamide, dimethylacetamide and N-methylpyrrolidone), an ether (such as diethyl ether, dioxane tetrahydrofuran), and an ether alcohol (such as 1-methoxy-2-propanol). Among these, toluene, xylene, methyl ethyl ketone, methyl isobutyl ketone, cyclohexanone and butanol are preferred.

Particularly preferred examples of the dispersion medium include methyl ethyl ketone, methyl isobutyl ketone and cyclohexanone.

The inorganic particles are dispersed by using a dispersing machine. Examples of the dispersing machine include a sand grinder mill (such as a beads mill with pins), a high-speed impeller mill, a pebble mill, a roller mill, an attritor and a colloid mill. A sand grinder mill and a high-speed impeller mill are particularly preferred. A preliminary dispersion process may be carried out. Examples of a dispersing machine used for the preliminary dispersion process include a ball mill, a three-roll mill, a kneader and an extruder.

The inorganic fine particles are preferably dispersed as finely as possible in the dispersion medium, and the weight average particle diameter thereof is generally from 1 to 200 nm, preferably from 5 to 150 nm, more preferably from 10 to 100 nm, and particularly preferably from 10 to 80 nm.

In the case where the inorganic particles are dispersed finely to 200 nm or less, the transparency of the high refractive index layer and the medium refractive index layer is not impaired.

The high refractive index layer and the medium refractive index layer in the invention are preferably formed in the following manner. The inorganic fine particles are dispersed in the dispersion medium to form a dispersion liquid, to which a binder precursor necessary for forming a matrix (such as a polyfunctional monomer and a polyfunctional oligomer having ionizing radiation curing property, described later) and a photo-polymerization initiator are added, to obtain a coating solution for forming the high refractive index layer or the medium refractive index layer. The coating solution for forming the high refractive index layer or the medium refractive index layer is coated on a transparent support, and cured through crosslinking reaction or polymerization reaction of the ionizing radiation curable compound (such as a polyfunctional monomer and a polyfunctional oligomer).

The binder of the high refractive index layer and the medium refractive index layer is preferably subjected to crosslinking reaction or polymerization reaction with the dispersing agent simultaneously with or after coating the layer.

The binder of the high refractive index layer and the medium refractive index layer thus formed in the manner contains the anionic group of the dispersing agent surrounded by the binder through crosslinking or polymerization reaction between the aforementioned preferred dispersing agent and the polyfunctional monomer or the polyfunctional oligomer having ionizing radiation curing property. The binder of the high refractive index layer and the medium refractive index layer also has a function of maintaining the dispersed state of the inorganic fine particles owing to the anionic group, and thus the crosslinked or polymerized structure imparts the film forming capability to the binder, so as to improve the physical strength, the chemical resistance and the weather resistance of the high refractive index layer and the medium refractive index layer having the inorganic fine particles dispersed therein.

The functional group of the polyfunctional monomer and the polyfunctional oligomer having ionizing radiation curing property for forming the binder is preferably a photo-, electron beam- or radiation-polymerizable group, and a photo-polymerizable group is preferred.

Examples of the photo-polymerizable functional group include an unsaturated polymerizable functional group, such as a (meth)acryloyl group, a vinyl group, a styryl group and an allyl group, and among these, a (meth)acryloyl group is preferred.

Specific examples of the photo-polymerizable polyfunctional monomer having a photo-polymerizable functional group include the monomers exemplified for the low refractive index layer. The polyfunctional monomers may be used in combination of two or more kinds thereof.

The high refractive index layer used in the invention may contain the organosilane compound represented by the general formula (A) or a derivative thereof, or may contain both of them.

In order to provide the low refractive index layer on the high refractive index layer to produce the antireflection film, the refractive index of the high refractive index layer is preferably from 1.55 to 2.40, more preferably from 1.60 to 2.20, further preferably from 1.65 to 2.10, and most preferably from 1.80 to 2.00.

The layers constituting the antireflection film of the invention may contain, in addition to the aforementioned component (i.e., the inorganic fine particles, the polymerization initiator, the photosensitizing agent and the like), a resin, a surface active agent, an antistatic agent, a coupling agent, a thickening agent, a coloration preventing agent, a coloring agent (such as a pigment and a dye), a defoaming agent, a leveling agent, a flame retarding agent, an ultraviolet ray absorbent, an infrared ray absorbent, an adhesion imparting agent, a polymerization inhibitor, an antioxidant, a surface modifier, electroconductive metallic fine particles, and the like.

The monomer having an ethylenic unsaturated group can be polymerized by irradiating with ionization radiation or by heating, in the presence of a photo-radical initiator or a heat-radical initiator.

Examples of the photo-radical initiator include an acetophenone compound, a benzoin compound, a benzophenone compound, a phosphine oxide compound, a ketal compound, an anthraquinone compound, a thioxanthone compound, an azo compound, a peroxide compound, a 2,3-dialkyldione compound, a disulfide compound, a fluoroamine compound, an aromatic sulfonium compound, a lophine dimer compound, an onium salt compound, a borate salt compound, an active ester compound, an active halogen compound, an inorganic complex compound and a coumarin compound.

Examples of the acetophenone compound include 2,2-dimethoxyacetophenone, 2,2-diethoxyacetophenone, p-dimethylacetophenone, 1-hydroxydimethylphenyl ketone, 1-hydroxydimethyl-p-isopropylphenyl ketone, 1-hydroxychclohexylphenyl ketone, 2-methyl-4-methylthio-2-morpholinopropiophenone, 2-benzyl-2-dimethylamino-1-(4-morpholinophenyl)butanone, 4-phenoxydichloroacetophenone and 4-t-butyldichloroacetophenone.

Examples of the benzoin compound include benzoin, benzoin methyl ether, benzoin ethyl ether, benzoin isopropyl ether, benzyldimethylketal, benzoin benzenesulfonate ester, benzoin toluenesulfonate ester, benzoin methyl ether, benzoin ethyl ether and benzoin propyl ether.

Examples of the benzophenone compound include benzophenone, hydroxybenzophenone, 4-benzoyl-4′-methyldiphenyl sulfide, 2,4-dichlorobenzophenone, 4,4-dichlorobenzophenone, p-chlorobenzophenone, 4,4′-dimethylaminobenzopbenone (Michler's ketone) and 3,3′,4,4′-tetra(t-butylperoxycabonyl)benzophenone.

Examples of the phosphine oxide include 2,4,6-trimethylbenzoyldiphenylphosphine oxide.

Examples of the active ester compound include 1,2-octanedione, 1-[4-(phenylthio)-2-(O-benzoyloxime)], a sulfonate ester compound and a cyclic active ester compound.

Specifically, the compounds 1 to 21 disclosed in the examples of JP-A-2000-80068 are preferred.

Examples of the onium salt compound include an aromatic diazonium salt, an aromatic iodonium salt and an aromatic sulfonium salt.

Examples of the borate salt compound include an ionic complex compound with a cationic dye.

Examples of the active halogen compound include S-triazine and an oxathiazole compound, and examples thereof include 2-(p-methoxyphenyl)-4,6-bis(trichloromethyl)-s-triazine, 2-(p-methoxyphenyl)-4,6-bis(trichloromethyl)-s-triazine, 2-(p-styrylphenyl)-4,6-bis(trichloromethyl)-s-triazine, 2-(3-bromo-4-di(ethyl acetate)amino)phenyl)-4,6-bis(trichloromethyl)-s-triazine and 2-trihalomethyl-5-(p-methoxyphenyl)-1,3,4-oxadiazole. Specifically, the compounds disclosed in p. 14 to 30 of JP-A-58-15503 and p. 6 to 10 of JP-A-55-77742, the compounds Nos. 1 to 8 disclosed in page 287 of JP-B-60-27673, the compound Nos. 1 to 17 disclosed in p. 443 to 444 of JP-A-60-239736, the compound Nos. 1 to 19 disclosed in U.S. Pat. No. 4,701,399 are particularly preferred.

Examples of the inorganic complex compound include bis(η⁵-2,4-cyclopentadiene-1-yl)-bis(2,6-difluoro)-3-(1H-pyrrole-1-yl)phenyl) titanium.

Examples of the coumarin compound include 3-ketocoumarin.

The initiators may be used solely or as a mixture thereof.

Various kinds of the initiators that are useful in the invention are disclosed in Saishin UV Kouka Gijutsu (Newest UV Curing Technique), p. 159, published by Technical Information Institute Co., Ltd. (1991) and K. Kato, Shigaisen Kouka System (Ultraviolet Curing System), p. 65 to 148, published by Sogo Gijutsu Center Co., Ltd.

Preferred examples of the commercially available photo-cleavage photo-radical initiator include Irgacure (651, 184, 819, 1879 (mixed initiator of CGI-403/Irgacure 184 (7/3), 500, 369, 1173, 2959, 4265 and 4263), OXE01), produced by Ciba Specialty Chemicals, Inc., KAYACURE (DETX-S, BP-100, BDMK, CTX, BMS, 2-EAQ, ABQ, CPTX, EPD, ITX, QTX, BTC and MCA), produced by Nippon Kayaku Co., Ltd., Esacure (KIP100F, KB1, EB3, BP, X33, KT046, KT37, KIP150 and TZT), produced by Sartomer Co., and combinations thereof.

The photopolymerization initiator is preferably used in an amount of from 0.1 to 15 parts by weight, and more preferably from 1 to 10 parts by weight, per 100 parts by weight of the polyfunctional monomer.

A photosensitizing agent may be used in addition to the photopolymerization initiator. Specific examples of the photosensitizing agent include n-butylamine, triethylamine, tri-n-butylphosphine, Michler's ketone and thioxanthone.

Furthermore, at least one kind of an assistant, such as an azide compound, a thiourea compound and a mercapto compound, may be used in combination.

Examples of the commercially available photosensitizing agent include KAYACURE (DMBI and EPA), produced by Nippon Kayaku Co., Ltd.

Examples of the heat-radical initiator include an organic or inorganic peroxide compound and an organic azo or diazo compound.

Specifically, examples of the organic peroxide compound include benzoyl peroxide, halogenated benzoyl peroxide, lauroyl peroxide, acetyl peroxide, dibutyl peroxide, cumene hydroperoxide and butyl hydroperoxide, examples of the inorganic peroxide compound include hydrogen peroxide, ammonium persulfate and potassium persulfate, examples of the azo compound include 2,2′-azobis(isobutyronitrile), 2,2′-azobis(propyonitrile) and 1,1′-azobis(cyclohexanecarbonitrile), and examples of the diazo compound include diazoaminobenzene and p-nitrobenzene diazonium.

Upon forming each of the layers constituting the antireflection film of the invention, the crosslinking reaction or the polymerization reaction of the ionizing radiation curable compound is preferably carried out in an atmosphere having an oxygen concentration of 10% by volume or less.

In the case where each of the layers are formed in an atmosphere having an oxygen concentration of 10% by volume or less, the physical strength, the chemical resistance and the weather resistance of the layers constituting the antireflection film can be improved, and furthermore, the adhesion between the layers adjacent to each other can also be improved.

Transparent Support

The antireflection film of the invention has a transparent support, and the layers are formed on the transparent support. The transparent support preferably has a light transmittance of 80% or more, and more preferably 86% or more. The transparent support preferably has a haze of 2.0% or less, and more preferably 1.0% or less. The transparent support preferably has a refractive index of from 1.4 to 1.7.

As the transparent support, a plastic film is preferred rather than a glass plate. Examples of the material for the plastic film include cellulose ester, polyamide, polycarbonate, polyester (such as polyethylene terephthalate, polyethylene naphthalate, poly-1,4-cyclohexanedimethylene terephthalate, polyethylene-1,2-diphenoxyethane-4,4′-dicarboxylate and polybutylene terephthalate), polystyrene (such as syndiotactic polystyrene), polyolefine (such as polypropylene, polyethylene and polymethyl pentene), polysulfone, polyethersulfone, polyarylate, polyetherimide, polymethyl methacrylate and polyether ketone. Among these, cellulose ester, polycarbonate, polyethylene terephthalate and polyethylene naphthalate are preferred.

In the case where the antireflection film of the invention is used in a liquid crystal display device, a cellulose acylate film is preferably used, and the cellulose acylate is produced by esterifying cellulose. The cellulose before the esterification may be produced by purifying from linter, kenaf or pulp.

In the invention, the cellulose acylate means an aliphatic acid ester of cellulose, and in particular, a lower aliphatic acid ester of cellulose is preferred. A film of an aliphatic acid ester of cellulose is preferred.

The lower aliphatic acid herein means an aliphatic acid having 6 or less carbon atoms. Cellulose acylate having from 2 to 4 carbon atoms is preferred, and cellulose acetate is particularly preferred. A mixed aliphatic acid ester of cellulose, such as cellulose acetate propionate and cellulose acetate butyrate, is also preferably used.

The viscosity average degree of polymerization (DP) of the cellulose acylate is preferably 250 or more, and more preferably 290 or more. The cellulose acylate has a narrow molecular weight distribution indicated in terms of Mw/Mn measured by gel permeation chromatography (wherein Mw represents the weight average molecular weight, and Mn represents the number average molecular weight). The specific value of Mw/Mn is preferably from 1.0 to 5.0, more preferably from 1.0 to 3.0, and particularly preferably from 1.0 to 2.0.

The transparent support in the invention is preferably cellulose acylate having an acetylation degree of from 55.0 to 62.5%, more preferably from 57.0 to 62.0%, and particularly preferably from 59.0 to 61.5%. The acetylation degree herein means the amount of acetic acid bonded per unit weight of cellulose. The acetylation degree can be obtained according to the measurement and calculation of an acylation degree in ASTM D-817-91 (Standard Test Methods of Testing Cellulose Acylate).

There is such a tendency in cellulose acylate that the hydroxyl groups at the 2-, 3- and 6-positions of cellulose are not equivalently substituted, but the substitution degree at the 6-position is smaller. It is preferred in the cellulose acylate used in the invention that the substitution degree of the 6-position is equivalent to or higher than those of the 2- and 3-positions.

The proportion of the substitution degree of the 6-position based on the total substitution degree of the 2-, 3- and 6-positions is preferably from 30 to 40%, more preferably from 31 to 40%, and most preferably from 32 to 40%.

Various kinds of additives may be added in the transparent support for adjusting the characteristics of the film including the mechanical characteristics (such as the strength, the curl, the dimensional stability and the lubrication property of the film) and the durability (such as the humidity and heat resistance and the weather resistance). Examples of the additives include a plasticizer (such as a phosphate ester, a phthalate ester, and an ester of a polyol and an aliphatic acid), an ultraviolet ray protecting agent (such as a hydroxybenzophenone compound, a benzotriazole compound, a salicylate ester compound and a cyanoacrylate compound), a degradation preventing agent (such as an antioxidant, a peroxide decomposing agent, a radical inhibitor, a metal inactivating agent, an acid scavenger and an amine), fine particles (such as SiO₂, Al₂O₃, TiO₂, BaSO₄, CaCO₃, MgCO₃, talc and kaolin), a parting agent, an antistatic agent, and an infrared absorbent.

With respect to the details of the additives, materials disclosed in JIII Journal of Technical Disclosure Monthly, No. 2001-1745, pp. 17-22 (published on Mar. 15, 2001 by JIII) are preferably used.

The using amount of the additives is preferably from 0.01 to 20% by weight, and more preferably from 0.05 to 10% by weight, based on the transparent support.

The transparent support may be subjected to a surface treatment.

Examples of the surface treatment include a chemical treatment, a mechanical treatment, a corona discharge treatment, a flame treatment, an ultraviolet ray irradiation treatment, a radio frequency treatment, a glow discharge treatment, an active plasma treatment, a laser treatment, a mixed acid treatment and an ozone oxidation treatment. Specific examples thereof include those described in JIII Journal of Technical Disclosure Monthly, No. 2001-1745, pp. 30-31 (published on Mar. 15, 2001) and JP-A-2001-9973.

Preferred examples of the surface treatment include a glow discharge treatment, an ultraviolet ray irradiation treatment, a corona discharge treatment and a flame treatment, and more preferred examples thereof include a glow discharge treatment and an ultraviolet ray irradiation treatment.

Process for producing Antireflection Film

The process for producing the antireflection film of the invention will be described.

The respective layers constituting the antireflection film can be formed by coating by the dip coating method, the air knife coating method, the curtain coating method, a roller coating method, a dye coating method, a wire bar coating method or a gravure coating method. Among the coating methods, a gravure coating method is preferred since a coating solution can be coated with high uniformity in thickness even when the coating amount is small as in the layers of the antireflection film. A microgravure method is more preferred out of the gravure coating method since higher uniformity in thickness can be obtained.

The coating solution can also be coated with high uniformity in thickness by the dye coating method. The dye coating method is preferred because the coated thickness can be relatively easily controlled as the coating solution is measured off before coating, and the solvent is less evaporated at the coating part. Two or more layers may be coated simultaneously. The method of simultaneous coating is disclosed in U.S. Pat. No. 2,761,791, No. 2,941,898; No. 3,508,947 and No. 3,526,528 and Y Harasaki, Coating Kogaku (Coating Engineering), p. 253, published by Asakura Shoten Co., Ltd. (1973).

As the order of forming the layers, a coating solution for forming the hardcoat layer is coated on the transparent support, and then dried by heating. Thereafter, the coated layer is irradiated with light or heated to polymerize the monomer for forming the hardcoat layer to effect curing. Thus the hardcoat layer is formed. A coating solution for forming the medium refractive index layer and the high refractive index layer or the low refractive index layer is then coated on the hardcoat layer, and thus the medium refractive index layer and the high refractive index layer or the low refractive index layer is formed by irradiating with light or heating. It is preferred upon forming the antireflection film of the invention that both light irradiation curing (i.e., so-called ionizing radiation curing) and thermal curing are used in combination for forming the same layer (particularly, the low refractive index layer). Upon effecting the thermal curing and the light irradiation curing, the thermal curing may be effected after the light irradiation curing as disclosed in WO 03/27189A, but the order thereof is not limited, and each of the thermal curing and the light irradiation curing may be effected by dividing into plural times. It is desirable that the light irradiation curing is carried out after the thermal curing, and it is particularly preferred that the light irradiation curing is carried out after the thermal curing in the case where at least one of the hydrolysate of the organosilane represented by the general formula (A) and a partial condensate thereof is used together.

The antireflection film of the invention thus produced generally has a haze value of from 3 to 20%, and preferably from 4 to 15%, and generally has an average reflectivity in a region of from 450 to 650 nm of 1.8% or less, and preferably 1.5% or less. The antireflection film of the invention provides good antidazzle property and antireflection property without deterioration in transmitted images owing to the haze value and the average reflectivity within the aforementioned ranges.

Polarizing Plate

The polarizing plate of the invention has a polarizing film having on both surfaces thereof two surface protective films, and at least one of the surface protective film is the antireflection film of the invention. Such a polarizing plate that is prevented in reflection of outside light and has excellent abrasion resistance and antifouling property can be obtained by using the antireflection film of the invention as the outermost layer. The antireflection film in the polarizing plate of the invention functions as a protective film, whereby the production cost can be reduced.

Image Displaying Apparatus

The antireflection film of the invention can be applied to an image displaying apparatus, such as a liquid crystal display (LCD) device, a plasma display panel (PDP), an electro-luminescence display (ELD) and a cathode ray tube (CRT) display device. Since the antireflection film of the invention has a transparent support, it is used by adhering the transparent support side onto the image display surface of the image displaying apparatus.

In the case where the antireflection film of the invention is used on one side of surface protective films of a polarizing plate, it can be favorably used in a transmission, reflective or semi-transmission liquid crystal display device of such a mode as twisted nematic (TN), super twisted nematic (STN), vertical alignment (VA), in-plane switching (IPS) and optically copensatory bend (OCB).

Examples of the liquid crystal cell of the VA mode include (1) a VA mode liquid crystal cell in a strict meaning, in which rod-like liquid crystal molecules are substantially aligned vertically upon applying no voltage and are substantially aligned horizontally upon applying a voltage (as described in JP-A-2-176625), and further include (2) a liquid crystal cell with multidomain of VA mode (MVA mode) for enhancing the viewing angle (as described in SID97, Digest of Tech. Papers (preprints), vol. 28, p. 845 (1997)), (3) a liquid crystal cell of such a mode that rod-like liquid crystal molecules are substantially aligned vertically upon applying no voltage and are aligned in twisted multidomain (ASM mode) (as described in preprints of Symposium on Liquid Crystals, Japan 1998, p. 58-59), and (4) a liquid crystal cell of SURVAIVAL mode (as announces in LCD International 98).

The liquid crystal cell of the OCB mode is a liquid crystal display apparatus using a bend orientation mode, in which rod-like liquid crystal molecules are aligned in opposite directions (symmetrically) in an upper part and a lower part of the liquid crystal cell, and disclosed in U.S. Pat. No. 4,583,825 and No. 5,410,422. The bend orientation mode liquid crystal cell has an optically self-compensation function owing to the rod-like liquid crystal molecules being symmetrically aligned in an upper part and a lower part of the liquid crystal cell. Therefore, the liquid crystal mode is referred to as an OCB (optically compensatory bend) liquid crystal mode. The liquid crystal display apparatus of the bend orientation mode advantageously has a high response speed.

In the ECB mode liquid crystal cell, rod-like liquid crystal molecules are substantially aligned horizontally upon applying no voltage, which is most frequently utilized in a color TFT liquid crystal display apparatus and disclosed in many literatures. For example, it is disclosed in “EL, PDP and LCD Displays”, published by Toray Research Center Co., Ltd. (2001).

In a liquid crystal display apparatus of the TN mode or the IPS mode, it is particularly preferred that, among two protective films on both surfaces, an optical compensating film having a viewing angle enhancing effect is used as one of the protective films opposite to the antireflection film of the invention, whereby such a polarizing plate can be obtained that has both the antireflection effect and the viewing angle enhancing effect with the thickness of only one polarizing plate.

### EXAMPLE

The invention will be specifically described with reference to the following examples, but the invention is not construed as being limited thereto. Unless otherwise indicated, all “parts” and “percents” are based on weight.

Synthesis of Perfluoroolefin Copolymer (1)

Perfluoroolefin Copolymer (1) 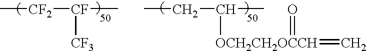
The term “50:50” represents a molar ratio

40 mL of ethyl acetate, 14.7 g of hydroxyethyl vinyl ether and 0.55 g of dilauroyl peroxide were charged in a stainless steel autoclave having an internal volume of 100 mL equipped with a stirrer, and the system was evacuated and replaced with nitrogen. 25 g of hexafluoropropylene (HFP) was introduced into the autoclave and heated to 65° C. The pressure at the time when the temperature inside the autoclave reached 65° C. was 0.53 MPa. The temperature was maintained to continue the reaction for 8 hours, and at the time when the pressure reached 0.31 MPa, heating was terminated, followed by allowing to stand for cooling. The non-reacted monomer was ejected at the time the internal temperature was lowered to room temperature, and the reaction solution was taken out after opening the autoclave. The reaction solution was put in a far excess amount of hexane, and the solvent was removed by decantation to take out the precipitated polymer. The polymer was dissolved in a small amount of ethyl acetate and reprecipitated twice from hexane to remove the remaining monomer completely. After drying, 28 g of the polymer was obtained. 20 g of the polymer was dissolved in 100 mL of N,N-dimethylacetamide, to which 11.4 g of acrylic acid chloride was added dropwise under cooling with ice, followed by stirring at room temperature for 10 hours. Ethyl acetate was added to the reaction solution, and after washing with water, the organic layer was extracted and concentrated. The resulting polymer was reprecipitated from hexane to obtain 19 g of the perfluoroolefin copolymer (1). The resulting polymer had a refractive index of 1.421. The weight average molecular weight was 28,000.

Preparation Sol Solution a

120 parts of methyl ethyl ketone, 100 parts of acryloyloxypropyltrimethoxysilane (KBM5103, produced by Shin-Etsu Chemical Co., Ltd.) and 3 parts of diisopropoxyaluminum ethylacetoacetate were mixed in a reaction vessel equipped with a stirrer and a reflux condenser, to which 30 parts of ion exchanged water was added. The mixture was reacted at 60° C. for 4 hours and then cooled to room temperature to obtain a sol solution a. The weight average molecular weight was 1,600, and the proportion of the component having a molecular weight of from 1,000 to 20,000 in the components larger than oligomers was 100%. Completely no acryloyloxypropyltrimethoxysilane as the raw material remained as confirmed by gas chromatography analysis.

Preparation of Coating Solution for Hardcoat Layer A

| | |
|---|---|
| KAYARAD PET-30 | 49.0 parts by weight |
| Irgacure 184 | 2.0 parts by weight |
| SX-350 (30%) | 2.2 parts by weight |
| Crosslinked acrylic-styrene | 13.3 parts by weight |
| Particles (30%) | |
| FP-132 | 0.75 part by weight |
| KBM-5103 | 10.5 parts by weight |
| Toluene | 38.5 parts by weight |

Preparation of Coating Solution for Hardcoat Layer B

| | |
|---|---|
| DeSolite Z7404 | 100 parts by weight |
| (hardcoat composition containing zirconia | |
| fine particles, produced by JSR Corp.) | |
| DPHA | 30 parts by weight |
| (UV curing resin, produced by Nippon | |
| Kayaku Co. Ltd.) | |
| KBM-5103 | 11 parts by weight |
| (silane coupling agent, produced by | |
| Shin-Etsu Chemical Co. Ltd.) | |
| KE-P150 | 8.9 parts by weight |
| (1.5 μm silica particles, produced | |
| by Nippon Shokubai Co., Ltd.) | |
| MXS-300 | 3.4 parts by weight |
| (3 μm crosslinked PMMA particles, produced by | |
| Soken Chemical & Engineering Co., Ltd.) | |
| MEK | 29 parts by weight |
| MIBK | 13 parts by weight |

Preparation of Coating Solution for Hardcoat Layer C

| | |
|---|---|
| Trimethylolpropane triacrylate | 740.0 parts by weight |
| (TMPTA (Viscoat 295, a trade name, produced | |
| by Osaka Organic Chemical Industry Ltd.) | |
| Poly(glycidyl methacrylate) | 280.0 parts by weight |
| (weight average molecular weight: 15,000) | |
| MEK | 730.0 parts by weight |
| Cyclohexanone | 500.0 parts by weight |
| Photo-polymerization initiator | 50.0 parts by weight |
| (Irgacure 184, produced by Nippon Ciba Geigy Ltd.) | |

The coating solutions A and B were filtered through a polypropylene filter with a pore size of 30 μm, and the coating solution C was filtered through a polypropylene filter with a pore size of 0.4 μm, to prepare coating solutions for a hardcoat layer.

Preparation of Titanium Dioxide Fine Particle Dispersion Liquid

Titanium dioxide fine particles containing cobalt and having been subjected to a surface treatment by using aluminum hydroxide and zirconium hydroxide (MPT-129C, produced by Ishihara Sangyo Kaisha, Ltd., TiO₂/Co₃O₄/Al₂O₃/ZrO₂=90.5/3.0/4.0/0.5 weight ratio) were used.

41.4 parts by weight of the following dispersing agent and 701.8 parts by weight of cyclohexanone were added to 257.1 parts by weight of the particles and dispersed in a Dinor mill to prepare a titanium dioxide dispersion liquid having a weight average particle diameter of 70 nm.
Dispersing Agent 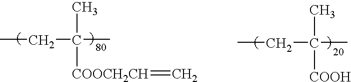
Preparation of Coating Solution for Medium Refractive Index Layer A

68.0 parts by weight of a mixture of dipentaerythritol pentaacrylate and dipentaerythritol hexaacrylate (DPHA), 3.6 parts by weight of a photo-polymerization initiator (Irgacure 907), 1.2 parts by weight of a photosensitizing agent (Kayacure DETX, produced by Nippon Kayaku Co., Ltd.), 279.6 parts by weight of methyl ethyl ketone and 1,049.0 parts by weight of cyclohexanone were added to 99.1 parts by weight of the titanium dioxide dispersion liquid, followed by stirring. After well stirring, the composition was filtered through a polypropylene filter having a pore size of 0.4 μm.

Preparation of Coating Solution for High Refractive Index Layer A

40.0 parts by weight of a mixture of dipentaerythritol pentaacrylate and dipentaerythritol hexaacrylate (DPHA), 3.3 parts by weight of a photo-polymerization initiator (Irgacure 907), 1.1 parts by weight of a photosensitizing agent (Kayacure DETX, produced by Nippon Kayaku Co., Ltd.), 526.2 parts by weight of methyl ethyl ketone and 459.6 parts by weight of cyclohexanone were added to 469.8 parts by weight of the titanium dioxide dispersion liquid, followed by stirring. After well stirring, the composition was filtered through a polypropylene filter having a pore size of 0.4 μm.

Preparation of Coating Solution for Low Refractive Index Layer A

| | |
|---|---|
| JN-7228A (6%) | 20.0 parts by weight |
| Cyclohexanone | 0.6 part by weight |

Preparation of Coating Solution for Low Refractive Index Layer B

| | |
|---|---|
| JN-7228A (8%) | 13.0 parts by weight |
| MEK-ST-L | 1.2 parts by weight |
| Sol solution a | 0.7 part by weight |
| MEK | 5.0 parts by weight |
| Cyclohexanone | 0.6 part by weight |

Preparation of Coating Solution for Low Refractive Index Layer C

| | |
|---|---|
| P-1 | 14.5 parts by weight |
| Irgacure 907 | 0.9 part by weight |
| MIBK | 84.7 parts by weight |

Preparation of Coating Solution for Low Refractive Index Layer D

| | |
|---|---|
| P-1 | 14.0 parts by weight |
| X-22-164C | 0.50 part by weight |
| Irgacure 907 | 0.9 part by weight |
| MIBK | 84.7 parts by weight |

Preparation of Coating Solution for Low Refractive Index Layer E

| | |
|---|---|
| P-1 | 7.7 parts by weight |
| X-22-164C | 0.50 part by weight |
| Irgacure 907 | 0.9 part by weight |
| MEK-ST-L | 2.9 parts by weight |
| Sol solution a | 1.3 parts by weight |
| MIBK | 86.8 parts by weight |

Preparation of Coating Solution for Low Refractive Index Layer F

| | |
|---|---|
| JTA-113 (6%) | 20.0 parts by weight |
| Cyclohexanone | 0.6 part by weight |

Preparation of Coating Solution for Low Refractive Index Layer G

| | |
|---|---|
| JTA-113 (6%) | 17.1 parts by weight |
| MEK-ST-L | 1.2 parts by weight |
| MEK | 1.5 parts by weight |
| Cyclohexanone | 0.6 part by weight |

Preparation of Coating Solution for Low Refractive Index Layer H

| | |
|---|---|
| JTA-113 (6%) | 13.0 parts by weight |
| MEK-ST-L | 1.2 parts by weight |
| Sol solution a | 0.7 part by weight |
| MEK | 5.0 parts by weight |
| Cyclohexanone | 0.6 part by weight |

Preparation of Coating Solution for Low Refractive Index Layer I

| | | |
|---|---|---|
| DPHA | 7.7 | parts by weight |
| X-22-164C | 0.50 | part by weight |
| Irgacure 907 | 0.9 | part by weight |
| MEK-ST-L | 2.9 | parts by weight |
| Sol solution a | 1.3 | parts by weight |
| MIBK | 86.8 | parts by weight |

Preparation of Coating Solution for Low Refractive Index Layer J

| | | |
|---|---|---|
| P-1 | 6.9 | parts by weight |
| DPHA | 0.80 | part by weight |
| X-22-164C | 0.50 | part by weight |
| Irgacure OXE01 | 0.90 | part by weight |
| MEK-ST-L | 2.9 | parts by weight |
| Sol solution a | 1.3 | parts by weight |
| MIBK | 86.8 | parts by weight |

Preparation of Coating Solution for Low Refractive Index Layer K

| | | |
|---|---|---|
| P-1 | 6.9 | parts by weight |
| DPHA | 0.80 | part by weight |
| X-22-164C | 0.50 | part by weight |
| Irgacure OXE01 | 0.90 | part by weight |
| Nipsil SS50F | 0.89 | part by weight |
| Sol solution a | 1.3 | parts by weight |
| MIBK | 86.8 | parts by weight |

Preparation of Coating Solution for Low Refractive Index Layer L

| | | |
|---|---|---|
| P-1 | 6.9 | parts by weight |
| DPHA | 0.80 | part by weight |
| X-22-164C | 0.50 | part by weight |
| Irgacure OXE01 | 0.90 | part by weight |
| Hollow silica sol | 1.34 | parts by weight |
| Sol solution a | 1.3 | parts by weight |
| MIBK | 86.8 | parts by weight |

Preparation of Coating Solution for Low Refractive Index Layer M

| | | |
|---|---|---|
| P-1 | 4.7 | parts by weight |
| DPHA | 0.80 | part by weight |
| X-22-164C | 0.50 | part by weight |
| Irgacure OXE01 | 0.90 | part by weight |
| Hollow silica sol | 4.69 | parts by weight |
| Sol solution a | 1.3 | parts by weight |
| MIBK | 86.8 | parts by weight |

Preparation of Coating Solution for Low Refractive Index Layer N

| | | |
|---|---|---|
| JTA-113 (6%) | 13.0 | parts by weight |
| Hollow silica sol | 1.8 | parts by weight |
| Sol solution a | 0.7 | part by weight |
| MEK | 5.0 | parts by weight |
| Cyclohexanone | 0.6 | part by weight |

Preparation of Coating Solution for Low Refractive Index Layer O

| | | |
|---|---|---|
| DPHA | 7.7 | parts by weight |
| X-22-164C | 0.50 | part by weight |
| Irgacure OXE01 | 0.90 | part by weight |
| Hollow silica sol | 4.4 | parts by weight |
| Sol solution a | 1.3 | parts by weight |
| MIBK | 86.8 | parts by weight |

The aforementioned solutions were stirred and filtered through a polypropylene filter having a pore size of 1 μm, respectively, to prepare coating solutions for low refractive index layers A to I.

The compounds used (detailed descriptions of which were omitted in the above) were as follows.
KAYARAD PET-30: a trade name, a mixture of pentaerythritol triacrylate and pentaerythritol tetraacrylate, produced by Nippon Kayaku Co., Ltd.
DeSolite Z7404: hardcoat composition, produced by JSR Corp., solid concentration: 60%, average particle diameter: 20 nm, content of zirconia particles: 70% based on the solid content
Irgacure 184: polymerization initiator, produced by Ciba Specialty Chemicals, Inc.
SX-350: 30% toluene dispersion liquid of crosslinked polystyrene particles, average particle diameter: 3.5 μm, refractive index: 1.60, produced by Soken Chemical & Engineering Co., Ltd., used after dispersing in a Polyton dispersing machine at 10,000 rpm for 20 minutes
Crosslinked acrylic-styrene Particles: 30% toluene dispersion liquid, average particle diameter: 3.5 μm, refractive index: 1.55, produced by Soken Chemical & Engineering Co., Ltd.
FP-132: fluorine surface modifying agent having the following structure 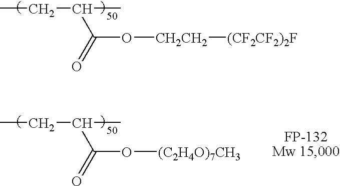
KBM-5103: silane coupling agent, produced by Shin-Etsu Chemical Co., Ltd.
JN-7228A: Opstar JN-7228A, a trade name, a thermally crosslinkable fluorine polymer, refractive index: 1.42, solid concentration: 6%, produced by JSR Corp.
JTA-113: Opstar JTA-113, a trade name, a thermally crosslinkable fluorine polymer, refractive index: 1.44, solid concentration: 6%, produced by JSR Corp.
P-1: Perfluoroolefin copolymer (1)
DPHA: a mixture of dipentaerythritol pentaacrylate and dipentaerythritol hexaacrylate, produced by Nippon Kayaku Co., Ltd.
MEK-ST-L: silica sol, silica having the same composition as MEK-ST with different particle diameter, refractive index: 1.46, average particle diameter: 45 nm, solid concentration: 30%, produced by Nissan Chemical Industries, Ltd.
X22-164C: reactive silicone, produced by Shin-Etsu Chemical Co., Ltd.
Irgacure 907: photo-polymerization initiator, produced by Ciba Specialty Chemicals, Inc.
Irgacure OXE01: photo-polymerization initiator, produced by Ciba Specialty Chemicals, Inc.
Nipsil SS50F: porous silica fine particles (refractive index: 1.38, produced by Nippon Silica Industries, Ltd.)
Hollow silica sol: silica content: 20%, cyclohexanone dispersion liquid having surface treating agent content: 6.0%, average particle diameter: 55 nm, particle refractive index: 1.30 (produced according to Preparation Example 4 of JP-A-2002-79616 with changing size and surface-treated by using acryloyloxypropyltrimethoxysilane (produced by Shin-Etsu Chemical Co., Ltd.)
MEK: Methyl ethyl ketone
MIBK: Methyl isobutyl ketone

### EXAMPLE 1

1-1 Coating of Hardcoat Layer A and Hardcoat Layer C

A rolled triacetyl cellulose film (TD80U, produced by Fuji Photo Film Co., Ltd.) as a support was wound off, on which the coating solution for a hardcoat layer was directly coated by using a microgravure roll of 50 mm in diameter having a gravure pattern with a line number of 180 per inch and a depth of 40 μm at a conveying speed of 30 m/min, and then dried at 60° C. for 150 seconds. The coated layer was cured by irradiating with an ultraviolet ray under a nitrogen purged atmosphere by using an air-cooled metallic halide lamp of 160 W/cm (produced by Eyegraphics Co., Ltd.) at an illuminance of 400 mW/cm² to an irradiance of 250 mJ/cm² for the hardcoat layer A or 300 mJ/cm² for the hardcoat layer C, so as to form a hardcoat layer, followed by winding the support. The rotation speed of the gravure roll was adjusted in such a manner that the thickness of the hardcoat layer after curing became 6 μm for the hardcoat layer A or 8 μm for the hardcoat layer C.

1-2 Coating of Hardcoat Layer B

A rolled triacetyl cellulose film (TD80U, produced by Fuji Photo Film Co., Ltd.) as a support was wound off, on which the coating solution for a hardcoat layer was directly coated by using a microgravure roll of 50 mm in diameter having a gravure pattern with a line number of 135 per inch and a depth of 60 μm at a conveying speed of 10 m/min, and then dried at 60° C. for 150 seconds. The coated layer was cured by irradiating with an ultraviolet ray under a nitrogen purged atmosphere by using an air-cooled metallic halide lamp of 160 W/cm (produced by Eyegraphics Co., Ltd.) at an illuminance of 400 mW/cm² to an irradiance of 250 mJ/cm², so as to form a hardcoat layer, followed by winding the support. The rotation speed of the gravure roll was adjusted in such a manner that the thickness of the hardcoat layer after curing became 3.6 μm.

2 Coating of Medium Refractive Index Layer A

The rolled triacetyl cellulose film (TD80U, produced by Fuji Photo Film Co., Ltd.) having the hardcoat layer coated thereon was again wound off, on which the coating solution for a medium refractive index layer was directly coated by using a microgravure roll of 50 mm in diameter having a gravure pattern with a line number of 180 per inch and a depth of 40 μm and a doctor blade. The drying conditions were 90° C. for 30 seconds, and the ultraviolet ray curing was effected in an atmosphere having an oxygen concentration controlled to below 1.0% by volume by nitrogen purging by using an air-cooled metallic halide lamp of 180 W/cm (produced by Eyegraphics Co., Ltd.) at an illuminance of 400 mW/cm² to an irradiance of 400 mJ/cm². The rotation speed of the gravure roll was adjusted in such a manner that the thickness of the layer after curing became 67 nm to form a medium refractive index layer, followed by winding the support. The medium refractive index layer after curing had a refractive index of 1.630.

3 Coating of High Refractive Index Layer A

The rolled triacetyl cellulose film (TD80U, produced by Fuji Photo Film Co., Ltd.) having until the medium refractive index layer coated thereon was again wound off, on which the coating solution for a high refractive index layer was directly coated by using a microgravure roll of 50 mm in diameter having a gravure pattern with a line number of 180 per inch and a depth of 40 μm and a doctor blade. The drying conditions were 90° C. for 30 seconds, and the ultraviolet ray curing was effected in an atmosphere having an oxygen concentration controlled to below 1.0% by volume by nitrogen purging by using an air-cooled metallic halide lamp of 240 W/cm (produced by Eyegraphics Co., Ltd.) at an illuminance of 600 mW/cm² to an irradiance of 400 mJ/cm². The rotation speed of the gravure roll was adjusted in such a manner that the thickness of the layer after curing became 107 nm to form a high refractive index layer, followed by winding the support. The high refractive index layer after curing had a refractive index of 1.905.

4-1 Coating of Low Refractive Index Layer (Coating and Curing Method A)

The rolled triacetyl cellulose film (TD80U, produced by Fuji Photo Film Co., Ltd.) having until the hardcoat layer or the high refractive index layer coated thereon was again wound off, on which the coating solution for a low refractive index layer was directly coated by using a microgravure roll of 50 mm in diameter having a gravure pattern with a line number of 180 per inch and a depth of 40 μm and a doctor blade, and then dried at 120° C. for 150 seconds and further subjected to post drying at 140° C. for 8 minutes. The coated layer was cured by irradiating with an ultraviolet ray under a nitrogen purged atmosphere having an oxygen concentration of 0.01% or less by using an air-cooled metallic halide lamp of 240 W/cm (produced by Eyegraphics Co., Ltd.) at an illuminance of 400 mW/cm² and an irradiance of 900 mJ/cm², so as to form a low refractive index layer, followed by winding the support. The rotation speed of the gravure roll was adjusted in such a manner that the thickness of the low refractive index layer after curing became 100 nm.

4-2 Coating of Low Refractive Index Layer (Coating and Curing Method B)

The same procedures as in the Coating and Curing Method A were carried out except that the post drying was omitted.

4-3 Coating of Low Refractive Index Layer (Coating and Curing Method C)

The same procedures as in the Coating and Curing Method A were carried out except that the curing step by irradiation of an ultraviolet ray was omitted.

4-4 Coating of Low Refractive Index Layer (Coating and Curing Method D)

The same procedures as in the Coating and Curing Method A were carried out except that the oxygen concentration in the curing step by irradiation of an ultraviolet ray was changed to 0.15%.

4-5 Coating of Low Refractive Index Layer (Coating and Curing Method E)

The same procedures as in the Coating and Curing Method A were carried out except that the curing step by irradiation of an ultraviolet ray was carried out before the post curing step.

4-6 Coating of Coating Film for Universal Hardness Evaluation (Coating and Curing Method F)

MEK solutions each containing 6% concentration of JN-7228Aor JTA-113 and all of polymer, a curing catalyst and a curing agent were prepared for the coating solutions for low refractive index layer A, B, F, Q H and N. These solutions were condensed to be their solid content of 25% concentration by a reduced rotary evaporator by using a vacuum pump under a condition of 30° C. heating. The condensed solutions were respectively coated on the aforementioned polished slide glass plate (26 mm×76 mm×1.2 mm), produced by Toshinriko Co., Ltd., with a bar coater that had been selected to provide a layer thickness after curing of 20 μm. The aforementioned universal hardness's of the samples cured under the heating conditions of at 120° C. for 5 min, 10 min, 30 min, 60 min, 100 min and 120 min respectively were plotted, and then the measured data of the sample cured under the heating condition of at 120° C. for 100 min, in which hardness changes did not occur and sufficiently stabilized, was shown in Table 1 as the universal hardness.

4-7 Coating of Coating Film for Universal Hardness Evaluation (Coating and Curing Method G)

Solutions each containing only the polymer P-1 and the polymerization initiator Irgacure 907 in the mentioned amounts were prepared for the coating solutions each having a solid content of 25% concentration for low refractive index layer C, D and E, a solution containing only DPHA and the polymerization initiator Irgacure 907 in the mentioned amounts was prepared for the coating solution having a solid content of 25% concentration for low refractive index layer I, solutions containing only the polymer P-1, DPHA and the polymerization initiator Irgacure 907 in the mentioned amounts were prepared for the coating solutions each having a solid content of 25% concentration for low refractive index layer J, K, L and M, and the coating solutions were respectively coated on the aforementioned polished slide glass plate (26 mm×76 mm×1.2 mm), produced by Toshinriko Co., Ltd., with a bar coater that had been selected to provide a layer thickness after curing of 20 nm. The aforementioned universal hardness's of the samples cured under the UV irradiation amounts conditions of from 250 mJ/cm² to 850 mJ/cm² by 100 mJ/cm² under an oxygen concentration of 12 ppm were plotted, and then the measured data of the sample cured under the UV irradiation amounts condition of 750 mJ/cm², in which hardness changes did not occur and sufficiently stabilized, was shown in Table 1 as the universal hardness.

Production of Samples of Antireflection Films

Samples of antireflection films Nos. 001 to 024 were produced in the aforementioned manners as shown in Table 1.

TABLE 1

| | | Medium/high | | | | |
|---|---|---|---|---|---|---|
| | Low refractive | refractive index | | Coating and | Universal | |
| Sample No. | index layer | layer | Hardcoat layer | curing method | hardness* | Note |
| 001 | A | — | A | C | 70 | comparison |
| 002 | B | — | A | C | 70 | comparison |
| 003 | B | — | A | A | 70 | comparison |
| 004 | C | — | A | B | 150 | invention |
| 005 | D | — | A | B | 150 | invention |
| 006 | E | — | A | B | 150 | invention |
| 007 | E | — | A | D | 150 | invention |
| 008 | E | — | A | A | 150 | invention |
| 009 | F | — | A | C | 90 | invention |
| 010 | G | — | A | C | 90 | invention |
| 011 | H | — | A | C | 90 | invention |
| 012 | H | — | A | A | 90 | invention |
| 013 | I | — | A | C | 300 | invention |
| 014 | B | — | B | A | 70 | comparison |
| 015 | H | — | B | A | 90 | invention |
| 016 | B | A/A | C | C | 70 | comparison |
| 017 | H | A/A | C | C | 90 | invention |
| 018 | H | — | A | E | 90 | invention |
| 019 | J | — | A | D | 170 | invention |
| 020 | K | — | A | D | 170 | invention |
| 021 | L | — | A | D | 170 | invention |
| 022 | M | — | A | D | 170 | invention |
| 023 | N | — | A | A | 90 | invention |
| 024 | O | — | A | C | 300 | invention |

*The universal hardness was measured for the respective binders by the method defined by the invention having been described on a glass plate.

Saponification Treatment of Antireflection Film

After producing the films, the samples were subjected to the following treatment.

A 1.5 mole/L sodium hydroxide aqueous solution was prepared and maintained at 55° C. A 0.01 mole/L diluted sulfuric acid aqueous solution was prepared and maintained at 35° C. The antireflection film thus produced was immersed in the sodium hydroxide aqueous solution for 2 minutes and then immersed in water to wash out the sodium hydroxide aqueous solution sufficiently. The sample was then immersed in the diluted sulfuric acid aqueous solution for 1 minute and then immersed in water to wash out the diluted sulfuric acid aqueous solution sufficiently. Finally, the sample was sufficiently dried at 120° C.

Evaluation of Antireflection Film

The film samples obtained after subjecting the saponification treatment were evaluated for the following factors.

1 Average Specular Reflectivity

A spectral reflectivity in a wavelength region of from 380 to 780 nm at an incident angle of 5° was measured by using a spectrophotometer (produced by JASCO Corp.). In a result, an average reflectivity in a wavelength region of from 450 to 650 nm is used as an average specular reflectivity.

2 Steel Wool Abrasion Resistance

A rubbing test was carried out by using a rubbing tester under the following conditions.
Environment for evaluation: 25° C., 60% RH
Rubbing material: Steel wool (Grade No. 0000, produced by Nihon Steel Wool Co., Ltd.) was wound on a rubbing tip end (1 cm×1 cm) of the tester, which was in contact with the sample, and fixed with a band.
Moving distance (one way): 13 cm
Rubbing speed: 13 cm/sec
Load: 500 g/cm²
Contact area at tip end: 1 cm×1 cm
Number of rubbing: 10 times

After subjecting to the rubbing test, an oily black ink was coated on the back surface of the sample, and abrasions on the rubbed part was observed by the naked eye with reflected light to evaluate based on the following standard.
A: No abrasion found even though carefully observed
B: Slight abrasion found by careful observation
BC: Weak abrasions found
C: Moderate abrasions found
CD to D: Apparent abrasions found
   3 Evaluation of Adhesion Strength

The surface of the antireflection film having the low reflective index layer was cut with a cutter knife to make 11 lines in the lengthwise direction and 11 lines in the transversal direction to form 100 squares, on which a polyester adhesive tape (No. 31B, produced by Nitto Denko Corp.) was adhered under pressure to carry out the adhesion test repeatedly in three time on the same position. The presence of peeled squares was observed by the naked eye to evaluate based on the following standard.
A: No peeled square found among 100 squares
B: 2 or less squares peeled among 100 squares
C: From 3 to 10 squares peeled among 100 squares
D: More than 10 squares peeled among 100 squares
   4 Oily Ink Wiping Test

The antireflection film was fixed on a glass surface with an adhesive, on which a circle of 5 mm in diameter was written in 3 rounds with a thin pen point of a black oily felt pen (Makki Gokuboso, a trade name, produced by Zebra Co., Ltd.). After 5 seconds from writing, the written part was wiped out reciprocally 20 times with a wiper (Bemcot, a trade name, produced by Asahi Kasei Corp.) folded 10 times under such a load that the bundle of the wiper was distorted. The operation of written in and wiping out was repeated under the aforementioned conditions until the oily ink mark could not be wiped out, and the number of times that the oily ink mark could be wiped out was obtained. The aforementioned test was repeated 4 times to obtain an average value, which was evaluated based on the following standard.
B: Wiped out 10 times or more
C: Wiped out several times or more and less than 10 times
D: Wiped out only once

DD: Could not be wiped out

TABLE 2

| | | Steel wool | | | | |
|---|---|---|---|---|---|---|
| | Average specular | abrasion | Oily ink wiping | Adhesion | Surface free | |
| Sample No. | reflectivity (%) | resistance | property | strength | energy (mN/m) | Note |
| 001 | 1.7 | D | B | D | 21 | comparison |
| 002 | 1.8 | D | B | C | 21 | comparison |
| 003 | 1.8 | CD | B | B | 21 | comparison |
| 004 | 1.8 | B | D | B | 28 | invention |
| 005 | 1.8 | B | B | B | 22 | invention |
| 006 | 1.8 | A | B | B | 23 | invention |
| 007 | 1.8 | C | C | B | 22 | invention |
| 008 | 1.8 | B | C | B | 23 | invention |
| 009 | 1.7 | B | B | C | 21 | invention |
| 010 | 1.8 | A | B | B | 21 | invention |
| 011 | 1.8 | A | B | B | 21 | invention |
| 012 | 1.8 | A | B | A | 21 | invention |
| 013 | 1.9 | A | C | B | 25 | invention |
| 014 | 1.2 | D | B | B | 21 | comparison |
| 015 | 1.2 | A | B | A | 21 | invention |
| 016 | 0.4 | D | B | C | 21 | comparison |
| 017 | 0.4 | A | B | B | 21 | invention |
| 018 | 1.8 | B | B | A | 22 | invention |
| 019 | 1.8 | B | B | B | 22 | invention |
| 020 | 1.6 | B | B | B | 22 | invention |
| 021 | 1.4 | A | B | B | 22 | invention |
| 022 | 1.3 | A | B | B | 22 | invention |
| 023 | 1.4 | A | B | A | 21 | invention |
| 024 | 1.5 | A | C | B | 25 | invention |

The following is understood from the results shown in Tables 1 and 2.

It is understood from comparison between the comparative samples Nos. 001 to 003 and the inventive samples Nos. 004 to 013 and comparison between the comparative samples Nos. 014 and 016 and the inventive samples Nos. 015 and 017 that the inventive samples are improved in abrasion resistance with low reflectivity maintained. The samples Nos. 005 and 006 having a lowered surface free energy comparing to sample No. 004 within the scope of the invention is further improved in abrasion resistance and oily ink wiping property. The samples having the hardness and surface free energy within the scope of the invention satisfy the abrasion resistance, the oily ink wiping property and the adhesion strength in a well balanced manner, and thus the total capability as an antireflection film is improved. Furthermore, it is apparent that the combination use of inorganic fine particles having a low refractive index (particularly hollow silica) attains not only reduction refractive index, but also improvements in abrasion resistance and oily ink wiping property (comparison of the samples Nos. 007 and 019 to 022).

### EXAMPLE 2

A polarizing plate having an antireflection film was produced by adhering the sample film of Example 1 to a polarizing film. A liquid crystal display device was produced by using the polarizing plate with the antireflection film disposed as the outermost layer. The liquid crystal display device suffered less reflection of outside light with indistinct reflected images to provide excellent visibility. The liquid crystal display device satisfied all the antifouling property, the dust adhesion resistance and the abrasion resistance, which were to be considered upon practical use.

It is also understood from comparison between the samples No. 007 and No. 008 and comparison between samples No. 011 and No. 012 that the coating and curing method using both thermal curing and ionizing radiation curing in combination provides favorable results, and thus further improved results can be obtained among the inventive samples by suitably combining the materials and the production process.

### EXAMPLE 3

A triacetyl cellulose film (TAC-TD80U, produced by Fuji Photo Film Co., Ltd.) having a thickness of 80 μm was immersed in a 1.5 mole/L sodium hydroxide aqueous solution at 55° C. for 2 minutes, and then neutralized and washed with water. A polarizing film was produced by adsorbing iodine to a polyvinyl alcohol film, followed by stretching. The triacetyl cellulose film and the antireflection film of Example 1 were adhered on both surfaces of the polarizing film for protecting the film to produce a polarizing plate. A polarizing plate on the viewing side of a transmission TN liquid crystal display device (having a polarization split film having a polarization selecting layer, D-BEF, produced by Sumitomo 3M, Ltd., between a backlight and liquid crystal cells) of a notebook computer was replaced by the polarizing plate thus obtained, so as to expose the antireflection film side of the polarizing plate as the most superficial aspect. The display device suffered less reflection of background to provide excellent visibility.

### EXAMPLE 4

A liquid crystal display device was produced by adhering the antireflection film of Example 1 to a transmission TN liquid crystal cell. A viewing angle enhancing film (Wideview Film SA-12B, produced by Fuji Photo Film Co., Ltd.) comprising an optical compensating layer, in which a discotic structure unit with a disc plane thereof being slanted to a plane of a transparent support of the viewing angle enhancing film and an angle between the disc plane of the discotic structure unit and the plane of the transparent support varies in the depth direction of the optically anisotropic layer, is used as a protective film on the liquid crystal cell side of the polarizing plate on the viewing side and a protective film on the liquid crystal side of the polarizing plate on the backlight side in the liquid crystal display device. As a result, such a liquid crystal display device was obtained that was excellent in contrast in a bright room, had a significantly large viewing angle in the vertical and horizontal directions, was extremely excellent in visibility, and exhibited high display quality.

### EXAMPLE 5

The antireflection film of Example 1 was adhered on a glass plate on the surface of an organic EL display device with an adhesive. As a result, such a display apparatus was obtained that was suppressed in reflection on the glass surface with high visibility and could sufficiently withstand fouling due to fingerprints and dusts.

### EXAMPLE 6

A polarizing plate having an antireflection film on one surface thereof was produced by using the antireflection film of Example 1, and the polarizing plate was adhered on the surface of a glass plate of an organic EL display in such a manner that the λ/4 plate was adhered on the surface of the polarizing plate opposite to the side having the antireflection film with the antireflection film being the outermost layer. The display device was suppressed in surface reflection and reflection on the inner surface of the glass plate to exhibit high quality display with extremely high visibility.

The antireflection film of the invention has sufficient antireflection capability and abrasion resistance, and further, antifouling property, and can be easily produced at low cost. In particular, the antireflection film produced by the process of the invention, in which the layers are formed by both thermal curing and ionizing radiation curing in combination, is significantly excellent in abrasion resistance.

The antireflection film of the invention is used as a protective film of a polarizing plate. The antireflection film and the polarizing plate of the invention can be preferably used in an image displaying apparatus, particularly a liquid crystal display device.

The entire disclosure of each and every foreign patent application from which the benefit of foreign priority has been claimed in the present application is incorporated herein by reference, as if fully set forth.

1. An antireflection film comprising:
a transparent support; and
a low refractive index layer as an outermost layer,
wherein the low refractive index layer comprises a crosslinkable compound capable of forming a cured film having a universal hardness of 75 N/mm² or more.

2. The antireflection film according to claim 1,
wherein the low refractive index layer has a surface free energy of 25 mN/m or less.

3. The antireflection film according to claim 1,
wherein the crosslinkable compound is a fluorine-containing compound.

4. The antireflection film as according to claim 1,
wherein the low refractive index layer comprises at least one of inorganic fine particles, a hydrolysate of an organosilane represented by formula (A) and a partial condensate of an organosilane represented by formula (A):
(R¹⁰)ₘ—Si(X)₄₋ₘ (A)
wherein each of R¹⁰('s) independently represents a substituted or unsubstituted alkyl group or a substituted or unsubstituted aryl group;
each of X('s) independently represents a hydroxyl group or a hydrolyzable group; and
m represents an integer of from 1 to 3.

5. The antireflection film according to claim 4,
wherein the low refractive index layer comprises inorganic fine particles having a refractive index of from 1.15 to 1.40.

6. The antireflection film according to claim 1,
wherein the crosslinkable compound is thermosetting.

7. A process for producing an antireflection film comprising:
applying a coating solution for forming a layer constituting an antireflection film according to claim 1, so as to form an applied solution; and
curing the applied solution to form a layer,
wherein the curing is carried out by both a thermal curing and an ionizing radiation curing in combination.

8. A polarizing plate comprising an antireflection film according to claim 1.

9. A liquid crystal display device comprising an antireflection film according to claim 1 or a polarizing plate according to claim 8.

10. An organic EL display device comprising an antireflection film according to claim 1 or a polarizing plate according to claim 8.
